(19) United States
(12) Patent Application Publication
(10) Pub. No.: US 2025/0039383 A1
(43) Pub. Date: Jan. 30, 2025

(54) METHOD FOR PICTURE PROCESSING AND STORAGE MEDIUM

(71) Applicant: GUANGDONG OPPO MOBILE TELECOMMUNICATIONS CORP., LTD., Dongguan (CN)

(72) Inventors: Hui YUAN, Dongguan (CN); Yao LIU, Dongguan (CN); Yanhan CHU, Dongguan (CN); Ming LI, Dongguan (CN)

(21) Appl. No.: 18/896,773

(22) Filed: Sep. 25, 2024

Related U.S. Application Data
(63) Continuation of application No. PCT/CN2022/083382, filed on Mar. 28, 2022.

(51) Int. Cl. H04N 19/126; H04N 19/154; H04N 19/176

(52) U.S. Cl. CPC H04N 19/126; H04N 19/154; H04N 19/176

(57) ABSTRACT

The disclosure provides a method for picture processing and a storage medium. The method includes the following. A bitstream is decoded to obtain a quantization coefficient of a current picture block. A quantization parameter corresponding to the current picture block is determined, and a transform coefficient of the current picture block is obtained by performing inverse quantization on the quantization coefficient based on the quantization parameter. A reconstructed picture block of the current picture block is determined according to the transform coefficient. An enhanced picture block is obtained by performing quality enhancement on the reconstructed picture block based on the quantization parameter.

### CROSS REFERENCE TO RELATED APPLICATION(S)

This application is a continuation of International Application No. PCT/CN2022/083382, filed Mar. 28, 2022, the entire disclosure of which is incorporated herein by reference.

### TECHNICAL FIELD

The disclosure relates to the field of video coding technology, and more particularly, to a method for picture processing and a storage medium.

### BACKGROUND

Digital video technology may be applied to various video apparatuses, such as digital televisions, smart phones, computers, electronic readers, or video players, etc. With development of video technology, the data amount in video data is large. In order to facilitate transmission of video data, the video apparatus implements video compression technology, so that video data can be transmitted or stored more efficiently.

Video compression will result in video distortion. In order to reduce the video distortion, reconstructed pictures need to be processed. However, current methods for picture processing cannot produce ideal processing results.

### SUMMARY

In a first aspect, a method for picture processing is provided in embodiments of the disclosure. The method includes the following. A bitstream is decoded to obtain a quantization coefficient of a current picture block. A quantization parameter corresponding to the current picture block is determined, and a transform coefficient of the current picture block is obtained by performing inverse quantization on the quantization coefficient based on the quantization parameter. A reconstructed picture block of the current picture block is determined according to the transform coefficient. An enhanced picture block is obtained by performing quality enhancement on the reconstructed picture block based on the quantization parameter.

In a second aspect, a method for picture processing is provided in embodiments of the disclosure. The method includes the following. A quantization parameter of a current picture block is determined, and the current picture block is encoded based on the quantization parameter to obtain a quantization coefficient of the current picture block. A residual block of the current picture block is obtained by performing inverse quantization on the quantization coefficient based on the quantization parameter of the current picture block. A reconstructed picture block of the current picture block is obtained according to the residual block. An enhanced picture block is obtained by performing quality enhancement on the reconstructed picture block based on the quantization parameter.

In a third aspect, a non-transitory computer-readable storage medium storing a bitstream is provided. The bitstream is generated according to the method in the second aspect.

### BRIEF DESCRIPTION OF THE DRAWINGS

FIG. 1 is a schematic block diagram of a video coding system involved in embodiments of the disclosure.

FIG. 2 is a schematic block diagram of a video encoder involved in embodiments of the disclosure.

FIG. 3 is a schematic block diagram of a video decoder involved in embodiments of the disclosure.

FIG. 4 is a schematic flowchart of a method for picture processing provided in embodiments of the disclosure.

FIG. 5 is a schematic diagram of picture processing involved in the disclosure.

FIG. 6 is a schematic diagram of an enhancement model involved in the disclosure.

FIG. 7 is a schematic diagram of an enhancement model involved in the disclosure.

FIG. 8 is a schematic diagram of a structure of a first feature-extraction layer involved in the disclosure.

FIG. 9 is a schematic diagram of another structure of a first feature-extraction layer involved in the disclosure.

FIG. 10 is a schematic diagram of another structure of a first feature-extraction layer involved in the disclosure.

FIG. 11 is a schematic diagram of another structure of a first feature-extraction layer involved in the disclosure.

FIG. 12 is a schematic diagram of a structure of a weighting layer involved in the disclosure.

FIG. 13 is a schematic diagram of a structure of an enhancement model involved in the disclosure.

FIG. 14 is a schematic diagram of another structure of an enhancement model involved in the disclosure.

FIG. 15 is a schematic diagram of another structure of an enhancement model involved in the disclosure.

FIG. 16 is a schematic diagram of another structure of an enhancement model involved in the disclosure.

FIG. 17 is a schematic diagram of another structure of an enhancement model involved in the disclosure.

FIG. 18 is a schematic diagram of another structure of an enhancement model involved in the disclosure.

FIG. 19 is a schematic flowchart of a method for picture processing provided in embodiments of the disclosure.

FIG. 20 is a schematic flowchart of a method for picture processing provided in embodiments of the disclosure.

FIG. 21 is a schematic flowchart of a method for picture processing provided in embodiments of the disclosure.

FIG. 22 is a schematic block diagram of an apparatus for picture processing provided in embodiments of the disclosure.

FIG. 23 is a schematic block diagram of an apparatus for picture processing provided in embodiments of the disclosure.

FIG. 24 is a schematic block diagram of an electronic device provided in embodiments of the disclosure.

FIG. 25 is a schematic block diagram of a video coding system provided in embodiments of the disclosure.

### DETAILED DESCRIPTION

The disclosure can be applied to the field of picture coding, video coding, hardware video coding, dedicated circuit video coding, real-time video coding, etc. For example, the solution in the disclosure may be incorporated into audio video coding standards (AVS), such as H.264/audio video coding (AVC) standard, H.265/high efficiency video coding (HEVC) standard, and H.266/versatile video coding (VVC) standard. Alternatively, the solution in the disclosure may be incorporated into other proprietary or industry standards, including ITU-TH.261, ISO/IECMPEG-1 Visual, ITU-TH.262 or ISO/IECMPEG-2Visual, ITU-TH.263, ISO/IECMPEG-4Visual, ITU-TH.264 (also known as ISO/IECMPEG-4AVC), including scalable video coding (SVC) and multi-view video coding (MVC) extensions. It should be understood that the techniques in the disclosure are not limited to any particular coding standard or technology.

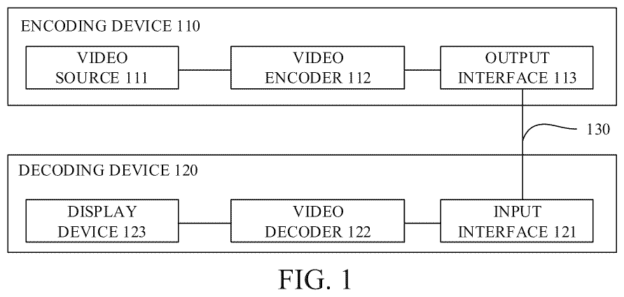

For ease of understanding, a video coding system in embodiments of the disclosure is firstly introduced with reference to FIG. 1.

FIG. 1 is a schematic block diagram of a video coding system 100 involved in embodiments of the disclosure. It should be noted that FIG. 1 is only an example, and the video coding system in embodiments of the disclosure includes but is not limited to that illustrated in FIG. 1. As illustrated in FIG. 1, the video coding system 100 includes an encoding device 110 and a decoding device 120. The encoding device is configured to encode (which can be understood as compress) video data to generate a bitstream, and transmit the bitstream to the decoding device. The decoding device decodes the bitstream generated by the encoding device to obtain decoded video data.

The encoding device 110 in the embodiments of the disclosure can be understood as a device having a video encoding function, and the decoding device 120 can be understood as a device having a video decoding function, that is, the encoding device 110 and the decoding device 120 in the embodiments of the disclosure include a wider range of devices, including smartphones, desktop computers, mobile computing devices, notebook (such as laptop) computers, tablet computers, set-top boxes, televisions, cameras, display devices, digital media players, video game consoles, vehicle-mounted computers, and the like.

In some embodiments, the encoding device 110 may transmit encoded video data (such as bitstream) to the decoding device 120 via a channel 130. The channel 130 may include one or more media and/or apparatuses capable of transmitting the encoded video data from the encoding device 110 to the decoding device 120.

In an example, the channel 130 includes one or more communication media that enable the encoding device 110 to transmit the encoded video data directly to the decoding device 120 in real-time. In this example, the encoding device 110 may modulate the encoded video data according to a communication standard and transmit the modulated video data to the decoding device 120. The communication medium includes a wireless communication medium, such as a radio frequency spectrum. Optionally, the communication medium may also include a wired communication medium, such as one or more physical transmission lines.

In another example, the channel 130 includes a storage medium that can store video data encoded by the encoding device 110. The storage medium includes a variety of local access data storage media, such as optical discs, digital versatile discs (DVDs), flash memory, and the like. In this example, the decoding device 120 may obtain the encoded video data from the storage medium.

In another example, the channel 130 may include a storage server that may store video data encoded by the encoding device 110. In this example, the decoding device 120 may download the stored encoded video data from the storage server. Optionally, the storage server may store the encoded video data and may transmit the encoded video data to the decoding device 120. For example, the storage server may be a web server (e.g., for a website), a file transfer protocol (FTP) server, and the like.

In some embodiments, the encoding device 110 includes a video encoder 112 and an output interface 113. The output interface 113 may include a modulator/demodulator (modem) and/or a transmitter.

In some embodiments, the encoding device 110 may include a video source 111 in addition to the video encoder 112 and the input interface 113.

The video source 111 may include at least one of a video capture apparatus (for example, a video camera), a video archive, a video input interface, or a computer graphics system, where the video input interface is configured to receive video data from a video content provider, and the computer graphics system is configured to generate video data.

The video encoder 112 encodes the video data from the video source 111 to generate a bitstream. The video data may include one or more pictures or a sequence of pictures. The bitstream contains encoding information of a picture or a sequence of pictures. The encoding information may include encoded picture data and associated data. The associated data may include a sequence parameter set (SPS), a picture parameter set (PPS), and other syntax structures. The SPS may contain parameters applied to one or more sequences. The PPS may contain parameters applied to one or more pictures. The syntax structure refers to a set of zero or multiple syntax elements arranged in a specified order in the bitstream.

The video encoder 112 directly transmits the encoded video data to the decoding device 120 via the output interface 113. The encoded video data may also be stored on a storage medium or a storage server for subsequent reading by the decoding device 120.

In some embodiments, the decoding device 120 includes an input interface 121 and a video decoder 122.

In some embodiments, the decoding device 120 may include a display device 123 in addition to the input interface 121 and the video decoder 122.

The input interface 121 includes a receiver and/or a modem. The input interface 121 may receive encoded video data through the channel 130.

The video decoder 122 is configured to decode the encoded video data to obtain decoded video data, and transmit the decoded video data to the display device 123.

The display device 123 displays the decoded video data. The display device 123 may be integrated together with the decoding device 120 or external to the decoding device 120. The display device 123 may include various display devices, such as a liquid crystal display (LCD), a plasma display, an organic light emitting diode (OLED) display, or other types of display devices.

In addition, FIG. 1 is only an example, and the technical solutions of the embodiments of the disclosure are not limited to FIG. 1. For example, the technology of the disclosure may also be applied to one-sided video encoding or one-sided video decoding.

In the following, a video encoding framework in embodiments of the disclosure will be introduced.

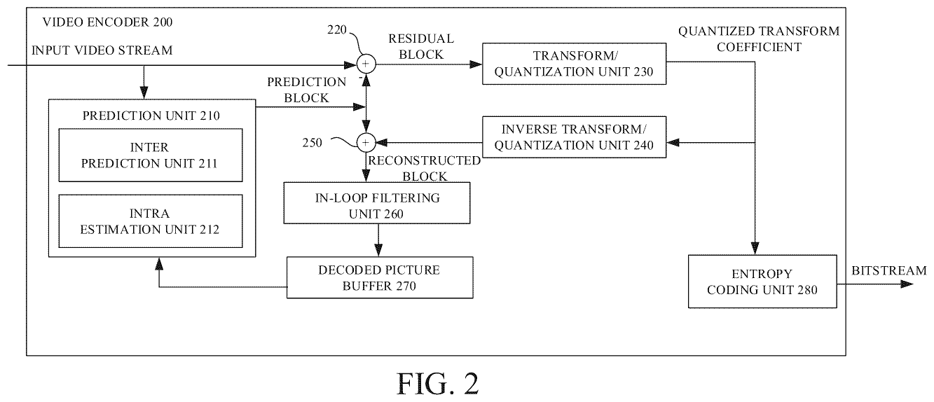

FIG. 2 is a schematic block diagram of a video encoder 200 involved in embodiments of the disclosure. It should be understood that the video encoder 200 may be configured to perform lossy compression or lossless compression on a picture. The lossless compression may be visually lossless compression or mathematically lossless compression.

The video encoder 200 may be applied to picture data in luma-chroma (YCbCr, YUV) format. For example, a YUV ratio can be 4:2:0, 4:2:2, or 4:4:4, where Y represents luminance (Luma), Cb (U) represents blue chrominance, and Cr (V) represents red chrominance. U and V represent chrominance (Chroma) for describing colour and saturation. For example, in terms of color format, 4:2:0 represents that every 4 pixels have 4 luma components and 2 chroma components (YYYYCbCr), 4:2:2 represents that every 4 pixels have 4 luma components and 4 chroma component (YYYYCbCrCbCr), and 4:4:4 represents full pixel display (YYYYCbCrCbCrCbCrCbCr).

For example, the video encoder 200 reads video data, and for each picture in the video data, partitions the picture into several coding tree units (CTU). In some examples, the CTU may be called “tree block”, “largest coding unit” (LCU), or “coding tree block” (CTB). Each CTU may be associated with a pixel block of the same size as the CTU within the picture. Each pixel may correspond to one luminance (luma) sample and two chrominance (chroma) samples. Thus, each CTU may be associated with one luma sample block and two chroma sample blocks. The CTU may have a size of 128×128, 64×64, 32×32, and so on. The CTU may be further partitioned into several coding units (CUs) for coding. The CU may be a rectangular block or a square block. The CU may be further partitioned into a prediction unit (PU) and a transform unit (TU), so that coding, prediction, and transform are separated, which is more conducive to flexibility in processing. In an example, the CTU is partitioned into CUs in a quadtree manner, and the CU is partitioned into TUs and PUs in a quadtree manner.

The video encoder and video decoder can support various PU sizes. Assuming that a size of a specific CU is 2N×2N, the video encoder and video decoder may support PUs of 2N×2N or N×N for intra prediction, and support symmetric PUs of 2N×2N, 2N×N, N×2N, N×N, or similar size for inter prediction; and the video encoder and video decoder may also support asymmetric PUs of 2N×nU, 2N×nD, nL×2N, or nR×2N for inter prediction.

In some embodiments, as illustrated in FIG. 2, the video encoder 200 may include a prediction unit 210, a residual unit 220, a transform/quantization unit 230, an inverse transform/quantization unit 240, a reconstruction unit 250, an in-loop filtering unit 260, a decoded picture buffer 270, and an entropy coding unit 280. It should be noted that the video encoder 200 may include more, fewer, or different functional components.

Optionally, in the disclosure, a current block may be referred to as a current CU or a current PU. A prediction block may be referred to as a prediction picture block or a picture prediction block. A reconstructed picture block may be referred to as a reconstructed block or a picture reconstructed block.

In some embodiments, the prediction unit 210 includes an inter prediction unit 211 and an intra estimation unit 212. Since there is a strong correlation between neighbouring samples in a video picture, intra prediction is used in the video coding technology to eliminate spatial redundancy between neighbouring samples. Since there is a strong similarity between neighbouring pictures in video, inter prediction is used in the video coding technology to eliminate temporal redundancy between neighbouring pictures, thereby improving encoding efficiency.

The inter prediction unit 211 may be used for inter prediction. The inter prediction may include motion estimation and motion compensation. In inter prediction, reference can be made to picture information of different pictures. In inter prediction, motion information is used to find a reference block from a reference picture, and a prediction block is generated according to the reference block to eliminate temporal redundancy. A frame for which inter prediction is used may be a P frame and/or a B frame, where P frame refers to a forward prediction frame, and B frame refers to bidirectional prediction frame. In inter prediction, the motion information is used to find a reference block from a reference picture, and a prediction block is generated according to the reference block. The motion information includes a reference picture list containing the reference picture, a reference picture index, and a motion vector. The motion vector can be an integer-sample motion vector or a fractional-sample motion vector. If the motion vector is the fractional-sample motion vector, interpolation filtering on the reference picture is required to generate a required fractional-sample block. Here, an integer-sample block or fractional-sample block found in the reference picture according to the motion vector is called a reference block. In some technologies, the reference block may be called a prediction block, and in some technologies, the prediction block will be generated based on the reference block. Generating the prediction block based on the reference block may also be understood as taking the reference block as a prediction block and then processing to generate a new prediction block based on the prediction block.

The intra estimation unit 212 predicts sample information of the current picture block only with reference to information of the same picture, so as to eliminate spatial redundancy. A frame used for intra prediction may be an I frame.

There are multiple prediction modes for intra prediction. Taking the international digital video coding standard H series as an example, there are 8 angular prediction modes and 1 non-angular prediction mode in H.264/AVC standard, which are extended to 33 angular prediction modes and 2 non-angular prediction modes in H.265/HEVC. The intra prediction mode used in HEVC includes a planar mode, direct current (DC), and 33 angular modes, and there are 35 prediction modes in total. The intra prediction mode used in VVC includes planar, DC, and 65 angular modes, and there are 67 prediction modes in total.

It should be noted that with increase of the number of angular modes, intra prediction will be more accurate, which will be more in line with demand for development of high-definition and ultra-high-definition digital video.

The residual unit 220 may generate a residual block of the CU based on a sample block of the CU and a prediction block of a PU. For example, the residual unit 220 may generate the residual block of the CU such that each sample in the residual block has a value equal to a difference between a sample in the sample block of the CU and a corresponding sample in the prediction block of the PU of the CU.

The transform/quantization unit 230 may quantize a transform coefficient. The transform/quantization unit 230 may quantize a transform coefficient associated with a TU of a CU based on a quantization parameter (QP) value associated with the CU. The video encoder 200 may adjust the degree of quantization applied to a transform coefficient associated with the CU by adjusting the QP value associated with the CU.

The inverse transform/quantization unit 240 may perform inverse quantization and inverse transform respectively on the quantized transform coefficient, to reconstruct a residual block from the quantized transform coefficient.

The reconstruction unit 250 may add samples in the reconstructed residual block to corresponding samples in one or more prediction blocks generated by the prediction unit 210, to generate a reconstructed picture block associated with the TU. By reconstructing sample blocks of each TU of the CU in this way, the video encoder 200 can reconstruct the sample block of the CU.

The in-loop filtering unit 260 is configured to process an inverse-transformed and inverse-quantized sample, compensate distorted information, and provide a better reference for subsequent sample encoding. For example, the in-loop filtering unit 260 may perform deblocking filtering operations to reduce blocking artifacts of the sample block associated with the CU.

In some embodiments, the in-loop filtering unit 260 includes a deblocking filtering unit and a sample adaptive offset/adaptive loop filtering (SAO/ALF) unit, where the deblocking filtering unit is configured for deblocking, and the SAO/ALF unit is configured to remove a ringing effect.

The decoded picture buffer 270 may store reconstructed sample blocks. The inter prediction unit 211 may use reference pictures including reconstructed sample blocks to perform inter prediction on PUs of other pictures. In addition, the intra estimation unit 212 may use the reconstructed sample blocks in the decoded picture buffer 270 to perform intra prediction on other PUs in the same picture as the CU.

The entropy coding unit 280 may receive the quantized transform coefficient from the transform/quantization unit 230. The entropy coding unit 280 may perform one or more entropy coding operations on the quantized transform coefficient to generate entropy coded data.

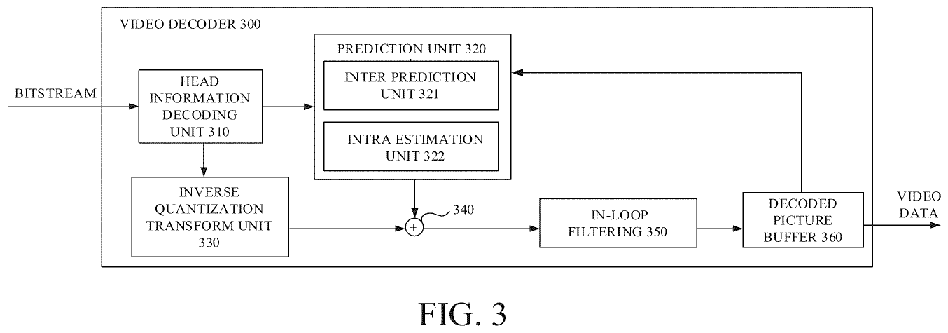

FIG. 3 is a schematic block diagram of a video decoder involved in embodiments of the disclosure.

As illustrated in FIG. 3, the video decoder 300 includes an entropy decoding unit 310, a prediction unit 320, an inverse quantization/transform unit 330, a reconstruction unit 340, an in-loop filtering unit 350, and a decoded picture buffer 360. It should be noted that the video decoder 300 may include more, fewer, or different functional components.

The video decoder 300 may receive a bitstream. The entropy decoding unit 310 may parse the bitstream to extract syntax elements from the bitstream. As part of parsing the bitstream, the entropy decoding unit 310 may parse entropy-coded syntax elements in the bitstream. The prediction unit 320, the inverse quantization/transform unit 330, the reconstruction unit 340, and the in-loop filtering unit 350 may decode video data according to the syntax elements extracted from the bitstream, that is, generate decoded video data.

In some embodiments, the prediction unit 320 includes an inter prediction unit 321 and an intra estimation unit 322.

The intra estimation unit 322 may perform intra prediction to generate a prediction block of a PU. The intra estimation unit 322 may use an intra-prediction mode to generate a prediction block of the PU based on a sample block of spatially neighbouring PUs. The intra estimation unit 322 may also determine an intra prediction mode for the PU from one or more syntax elements parsed from the bitstream.

The inter prediction unit 321 can construct a first reference picture list (list 0) and a second reference picture list (list 1) according to the syntax elements parsed from the bitstream. In addition, the entropy decoding unit 310 may parse motion information of the PU if the PU is encoded using inter prediction. The inter prediction unit 321 may determine one or more reference blocks of the PU according to the motion information of the PU. The inter prediction unit 321 may generate a prediction block of the PU based on one or more reference blocks of the PU.

The inverse quantization/transform unit 330 may perform inverse quantization on (that is, dequantize) a transform coefficient associated with a TU. The inverse quantization/transform unit 330 may use a QP value associated with a CU of the TU to determine the degree of quantization.

After inverse quantization of the transform coefficient, the inverse quantization/transform unit 330 may perform one or more inverse transforms on the inverse-quantized transform coefficient in order to generate a residual block associated with the TU.

The reconstruction unit 340 uses the residual block associated with the TU of the CU and the prediction block of the PU of the CU to reconstruct a sample block of the CU. For example, the reconstruction unit 340 may add samples in the residual block to corresponding samples in the prediction block to reconstruct the sample block of the CU to obtain the reconstructed picture block.

The in-loop filtering unit 350 may perform deblocking filtering to reduce blocking artifacts of the sample block associated with the CU.

The video decoder 300 may store the reconstructed picture of the CU in the decoded picture buffer 360. The video decoder 300 may use the reconstructed picture in the decoded picture buffer 360 as a reference picture for subsequent prediction, or transmit the reconstructed picture to a display device for display.

A basic process of video coding is as follows. At an encoding end, a picture is partitioned into CUs, and for a current block (i.e., current CU), the prediction unit 210 performs intra prediction or inter prediction to generate a prediction block of the current block. The residual unit 220 may calculate a residual block based on the prediction block and an original block of the current block, that is, a difference between the prediction block and the original block of the current block, where the residual block may also be referred to as residual information. The residual block can be transformed and quantized by the transform/quantization unit 230 to remove information that is not sensitive to human eyes, so as to eliminate visual redundancy. Optionally, the residual block before being transformed and quantized by the transform/quantization unit 230 may be called a time-domain residual block, and the time-domain residual block after being transformed and quantized by the transform/quantization unit 230 may be called a frequency residual block or a frequency-domain residual block. The entropy coding unit 280 receives the quantized transform coefficient output by the transform/quantization unit 230, and may perform entropy coding on the quantized transform coefficient to output a bitstream. For example, the entropy coding unit 280 can eliminate character redundancy according to a target context model and probability information of a binary bitstream.

At a decoding end, the entropy decoding unit 310 may parse the bitstream to obtain prediction information, a quantization coefficient matrix, etc. of the current block, and the prediction unit 320 performs intra prediction or inter prediction on the current block based on the prediction information to generate a prediction block of the current block. The inverse quantization/transform unit 330 uses the quantization coefficient matrix obtained from the bitstream to perform inverse quantization and inverse transform on the quantization coefficient matrix to obtain a residual block. The reconstruction unit 340 adds the prediction block and the residual block to obtain a reconstructed block. The reconstructed blocks form a reconstructed picture. The in-loop filtering unit 350 performs in-loop filtering on the reconstructed picture on a picture basis or on a block basis to obtain a decoded picture. Similar operations are also required at the encoding end for obtaining the decoded picture. The decoded picture may also be referred to as a reconstructed picture, and the reconstructed picture may be a reference picture of a subsequent picture for inter prediction.

It should be noted that block partition information as well as mode information or parameter information for prediction, transform, quantization, entropy coding, and in-loop filtering, etc. determined at the encoding end is carried in the bitstream when necessary. At the decoding end, the bitstream parsed and existing information is analyzed to determine the block partition information as well as the mode information or the parameter information for prediction, transform, quantization, entropy coding, in-loop filtering, etc. that is the same as such information at the encoding end, so as to ensure the decoded picture obtained at the encoding end is the same as the decoded picture obtained at the decoding end.

The current block may be a current CU or a current PU, etc.

The above is the basic process of video coding under a block-based hybrid coding framework. With development of technology, some modules or steps of the framework or process may be optimized. The disclosure is applicable to the basic process of the video coder under the block-based hybrid coding framework, but is not limited to the framework and process.

The following is an introduction to a method for picture encoding provided in embodiments of the disclosure in conjunction with specific embodiments.

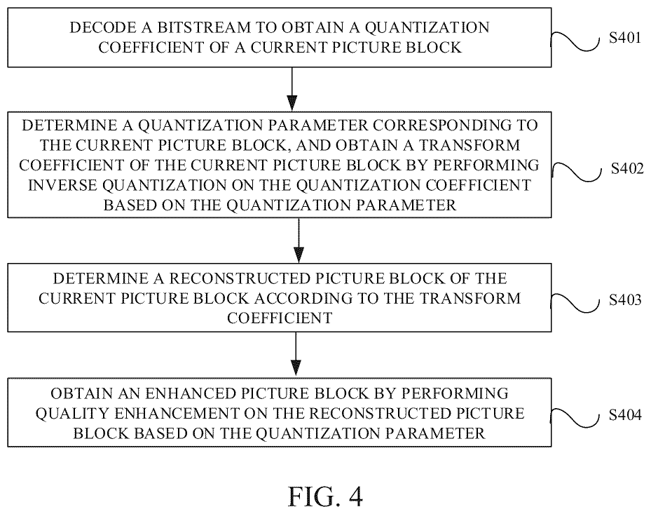

First, in conjunction with FIG. 4, taking the decoding end as an example, a method for video decoding provided in embodiments of the disclosure is introduced.

FIG. 4 is a schematic flowchart of a method for video decoding provided in embodiments of the disclosure. Embodiments of the disclosure are applicable to the video decoder illustrated in FIGS. 1 and 3.

As illustrated in FIG. 4, the method in embodiments of the disclosure includes the following.

S401. A bitstream is decoded to obtain a quantization coefficient of a current picture block.

The specific size of the current picture block is not limited in embodiments of the disclosure.

In some embodiments, the current picture block in embodiments of the disclosure is a CTU. For example, one picture is divided into several CTUs. The size of the CTU is not limited in the disclosure. For example, the size of the CTU may be 128×128, 64×64, 32×32, etc.

In some embodiments, the current picture block in embodiments of the disclosure is a CU. For example, one CTU is divided into one or more CUs.

In some embodiments, the current picture block in embodiments of the disclosure is a TU or a PU. For example, one CU is divided into one or more TUs or PUs.

In some embodiments, the current picture block in embodiments of the disclosure only includes a chroma component and can be understood as a chroma block.

In some embodiments, the current picture block in embodiments of the disclosure only includes a luma component and can be understood as a luma block.

In some embodiments, the current picture block includes both a luma component and a chroma component.

It should be noted that, if the current picture block includes multiple CUs, the quantization coefficient of the current picture block includes quantization coefficients corresponding to the multiple CUs.

As illustrated in FIG. 3, at the decoding end, the entropy decoding unit 310 may decode the bitstream to obtain prediction information, quantization information, etc. of the current picture block. The prediction unit 320 performs intra prediction or inter prediction on the current picture block based on the prediction information to generate a prediction value of the current picture block. The inverse quantization/transform unit 330 uses the quantization coefficient matrix obtained from the bitstream to perform inverse quantization and inverse transform on the quantization coefficient matrix to obtain a residual block. The reconstruction unit 340 adds the prediction block and the residual block to obtain a reconstructed picture block of the current picture block.

Video distortion may occur during video encoding. In order to reduce the distortion, in embodiments of the disclosure, post-processing is performed on the reconstructed picture block. That is, picture quality enhancement is performed by taking the picture block as an enhancement unit to improve the quality of the reconstructed picture block.

It should be noted that, if the current picture block includes multiple CUs, the CUS can be decoded separately to obtain a reconstructed block of each CU, and the reconstructed blocks of the CUs are combined to obtain the reconstructed picture block of the current picture block.

S402. A quantization parameter corresponding to the current picture block is determined, and a transform coefficient of the current picture block is obtained by performing inverse quantization on the quantization coefficient based on the quantization parameter.

It should be noted that, if the current picture block includes multiple CUs, the quantization parameter of the current picture block includes quantization parameters corresponding to the multiple CUs. Optionally, the quantization parameters corresponding to the multiple CUs may be the same or different.

In a possible implementation, the quantization parameter of the current picture block in embodiments of the disclosure may be in the form of a matrix. For example, if the size of the current picture block is 16×16, the quantization parameter of the current picture block is a 16×16 matrix, and each element in the matrix is the quantization parameter of the pixel at the corresponding position in the current picture block.

The specific process of determining the quantization parameter corresponding to the current picture block is not limited in embodiments of the disclosure.

In some embodiments, the encoding end and the decoding end use a default quantization parameter as the quantization parameter corresponding to the current picture block. In this case, the decoding end can directly determine the default quantization parameter as the quantization parameter corresponding to the current picture block.

In some embodiments, the encoding end signals the quantization parameter corresponding to the current picture block determined during encoding in the bitstream, so that the decoding end can determine the quantization parameter corresponding to the current picture block by decoding the bitstream.

In some embodiments, the decoding end may determine the quantization parameter corresponding to the current picture block through calculation using the same calculation method as the encoding end.

After determining the quantization parameter corresponding to the current picture block, the decoding end performs inverse quantization on the quantization coefficient of the current picture block based on the quantization parameter to obtain the transform coefficient of the current picture block.

For example, if the current picture block includes multiple CUs, for each CU, a transform coefficient of the CU is obtained by performing inverse quantization on a quantization coefficient of the CU based on a quantization parameter corresponding to the CU.

S403. A reconstructed picture block of the current picture block is determined according to the transform coefficient.

Specifically, a residual block of the current picture block is obtained by performing inverse transform on the transform coefficient of the current picture block. Also, a prediction block of the current picture block is obtained through prediction, such as intra prediction or inter prediction. The prediction value of the current picture block is added to the residual block of the current picture block to obtain the reconstructed picture block of the current picture block.

It should be noted that, if the current picture block includes multiple CUs, the quantization parameter corresponding to the current picture block are quantization parameters of the multiple CUs. During decoding, the CUs in the current picture block are decoded separately to obtain a reconstructed block of each CU, and the reconstructed blocks of the CUs are combined to obtain the reconstructed picture block of the current picture block.

S404. An enhanced picture block is obtained by performing quality enhancement on the reconstructed picture block based on the quantization parameter.

During video encoding, different picture blocks may correspond to different quantization parameters (QPs). In some embodiments, the QP includes a quantization step size. During video encoding, the transform coefficient of the picture block is quantized. The larger the quantization step size, the more the picture loss, and the smaller the quantization step size, the less the picture loss. Therefore, in order to improve the enhancement effect on the current picture block, in embodiments of the disclosure, during quality enhancement of the current picture block, the influence of the QP corresponding to the current picture block on quality enhancement is considered, thereby improving the effect of quality enhancement on the current picture block.

Different quantization coefficients result in different losses during inverse quantization of a picture block, in order to improve the enhancement effect on the picture block, in embodiments of the disclosure, quality enhancement is performed on the reconstructed picture block of the current picture block based on the quantization coefficient corresponding to the current picture block, thereby improving the enhancement effect on the reconstructed picture block.

In embodiments of the disclosure, picture quality enhancement is performed in units of picture blocks, so that when an enhanced picture block is used as a reference block for other picture blocks in intra prediction, a more accurate reference can be provided, thereby improving the accuracy of intra prediction.

In addition, in embodiments of the disclosure, picture quality enhancement is performed in units of picture blocks. As such, compared with performing picture quality enhancement on a picture as a whole, more emphasis can be placed on enhancement on finer features in picture blocks, thereby further improving the enhancement quality of the picture block.

In embodiments of the disclosure, the manner for obtaining the enhanced picture block by performing quality enhancement on the reconstructed picture block based on the quantization parameter is not limited.

In a possible implementation, different enhancement models are trained in advance for different quantization parameters, and an enhancement model corresponding to a different quantization parameter is used for quality enhancement of a picture block corresponding to the quantization parameter. In this way, the decoding end can select a target enhancement model corresponding to the quantization parameter of the current picture block from multiple enhancement models corresponding to different quantization parameters according to the quantization parameter of the current picture block, and use the target enhancement model to perform quality enhancement on the reconstructed picture block of the current picture block.

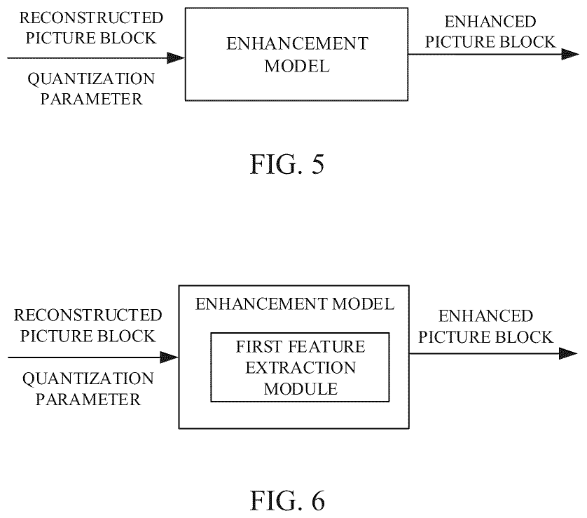

In another possible implementation, the decoding end obtains a general enhancement model, which is trained based on different picture blocks and their corresponding quantization parameters, and fully learns the influence of different quantization parameters on quality enhancement of picture blocks, and thus can perform, based on different quantization parameters, better quality enhancement on reconstructed picture blocks obtained after inverse quantization based on these different quantization parameters. In this way, the decoding end can obtain the enhanced picture block by performing quality enhancement on the reconstructed picture block with the general enhancement model based on the quantization parameter. Specifically, after determining the reconstructed picture block and the quantization coefficient of the current picture block in above steps, in order to reduce the distortion of the reconstructed picture block and improve the quality of the reconstructed picture block, as illustrated in FIG. 5, the decoding end inputs the reconstructed picture block and the corresponding quantization coefficient into the pre-trained enhancement model for picture enhancement, and finally obtains the enhanced picture block of the current picture block.

The following embodiments all take the general enhancement model as an example to introduce quality enhancement of the reconstructed picture block.

In some embodiments, at the decoding end, the reconstructed picture block and the quantization parameter are fused and then input into the enhancement model. The fusion manner of the reconstructed picture block and the quantization parameter includes at least the following examples.

Example 1. Assume that the size of the reconstructed picture block is N1*N2, where N1 and N2 can be the same or different. The reconstructed picture block is multiplied by the quantization parameter and then input into the enhancement model. Specifically, each pixel of the reconstructed picture block is multiplied by the quantization parameter to obtain a matrix of N1*N2, and the matrix is input into the enhancement model.

Example 2. The reconstructed picture and the quantization parameter are concatenated and then input into the enhancement model. Specifically, the quantization coefficient is set as a matrix of N1*N2, and the reconstructed picture of N1*N2 and the quantization parameter of N1*N2 are concatenated and then input into the enhancement model.

It should be noted that, in addition to the fusion manners illustrated in Examples 1 and 2 above, the decoding end may also fuse the reconstructed picture and the corresponding quantization parameter in other fusion manners and then input them into the enhancement model for quality enhancement.

In some embodiments, in order to prevent features with smaller absolute values from being covered by features with larger absolute values, the reconstructed picture block and quantization parameter are normalized by the decoding end before input into the enhancement model, so that all features are treated equally. Then, based on the normalized reconstructed picture block and quantization parameter, the enhanced picture block of the reconstructed picture blocks is obtained. For example, the normalized reconstructed picture block and quantization parameter are concatenated and then input into the enhancement model for quality enhancement, so as to improve the effect of quality enhancement.

In embodiments of the disclosure, the reconstructed picture block is a reconstructed picture block of the current picture block for a first component.

The first component may be a luma component or a chroma component.

In some embodiments, S404 includes the following S404-A and S404-B.

S404-A. First feature information of the reconstructed picture block is obtained by performing feature weighting on the reconstructed picture block based on the quantization parameter.

S404-B. The enhanced picture block is determined according to the first feature information.

The specific implementation of S404-A is not limited in embodiments of the disclosure.

In a possible implementation, feature information of the reconstructed picture block is extracted based on the quantization parameter. For example, the quantization parameter and the reconstructed picture block are input into a neural network layer to extract the feature information of the reconstructed picture block. Then, the feature information is analyzed and different weights are assigned to different features. For example, a larger weight is assigned to an important feature in the feature information to enhance the influence of the feature, and a smaller weight is assigned to an unimportant feature in the feature information to weaken the influence of the feature. Then, the first feature information of the reconstructed picture block is obtained by weighting the feature information of the reconstructed picture block according to weights corresponding to respective features.

In another possible implementation, as illustrated in FIG. 6, the enhancement model in embodiments of the disclosure includes a first feature-extraction module. The first feature-extraction module is configured to extract at least one feature of the input information, i.e., the reconstructed picture block and the quantization parameter, and assign different weights to the at least one extracted feature for feature weighting.

As illustrated in FIG. 6, in embodiments of the disclosure, the enhancement model includes a first feature-extraction module. The first feature-extraction module is configured to weight extracted features. Specifically, the reconstructed picture block and the quantization parameter (optionally, after being fused in the manner of Example 1 or Example 2) are input into the first feature-extraction module. The first feature-extraction module performs feature extraction to extract at least one feature, and assigns a larger weight to an important feature among the at least one feature to enhance the influence of the feature, and assigns a smaller weight to an unimportant feature among the at least one feature to weaken the influence of the feature. Then, the first feature-extraction module performs weighting according to the weight corresponding to the at least one feature to obtain the first feature information of the reconstructed picture block. Finally, based on the first feature information of the reconstructed picture block, the enhanced picture block of the reconstructed picture block is determined.

In embodiments of the disclosure, different weights can be assigned to different features to enhance the influence of important features and weaken the influence of unimportant features, thereby further improving the effect of quality enhancement on the reconstructed picture block.

The network model of the first feature-extraction module is not limited in embodiments of the disclosure. For example, the first feature-extraction module includes multiple convolutional layers and attention mechanisms, etc.

In another possible implementation, S404-A includes the following.

S404-A1. i-th feature information of the reconstructed picture block is obtained by performing feature weighting on (i-1)-th feature information of the reconstructed picture block based on the quantization parameter, where i is a positive integer from 1 to N, and N-th feature information of the reconstructed picture block is obtained by repeating feature weighting, where when i=1, the (i-1)-th feature information is the reconstructed picture block.

S404-A2. The first feature information of the reconstructed picture block is determined according to the N-th feature information.

In this implementation, the decoding end performs N feature weighting iterations on the reconstructed picture block based on the quantization parameter to obtain the N-th feature information of the reconstructed picture block. Specifically, feature weighting is performed on the reconstructed picture block based on the quantization parameter to obtain the 1st feature information of the reconstructed picture block. Then, feature weighting is performed on the 1st feature information to obtain the 2nd feature information of the reconstructed picture block. The process is performed iteratively and feature weighting is performed on the (N-1)-th feature information based on the quantization parameter to obtain the N-th feature information of the reconstructed picture block. It should be noted that, the specific manner of feature weighting is not limited in embodiments of the disclosure. Exemplarily, the quantization parameter and the (i-1)-th feature information are input into a neural network with feature weighting function to obtain the i-th feature information of the reconstructed picture block.

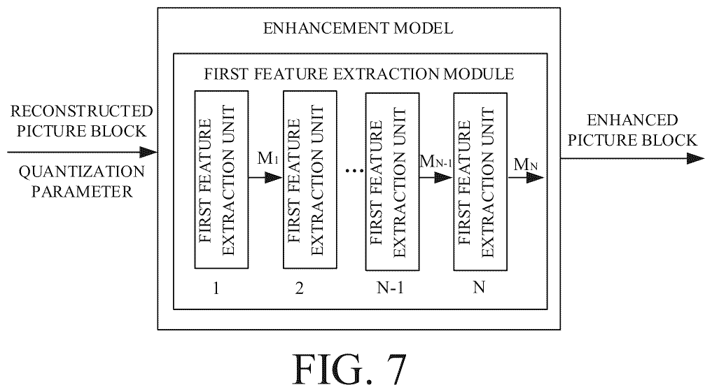

In some embodiments, as illustrated in FIG. 7, the first feature-extraction module in embodiments of the disclosure includes N first feature-extraction units. If N is greater than 1, the N first feature-extraction units are connected in series, that is, the output of the previous first feature-extraction unit is the input of the next first feature-extraction unit. The reconstructed picture block is subjected to feature weighting by the N first feature-extraction units based on the quantization parameter to obtain the N-th feature information of the reconstructed picture block. As illustrated in FIG. 7, each of the N first feature-extraction units is configured to extract at least one feature, and assign a larger weight to an important feature among the at least one feature to enhance the influence of the feature, and assign a smaller weight to an unimportant feature among the at least one feature to weaken the influence of the feature. The next first feature-extraction unit further performs feature extraction and weight assignment on the feature information output by the previous first feature-extraction unit, so as to further highlight important features. After the processing by the N first feature-extraction units, important features of the reconstructed picture block can be primarily enhanced, and unimportant features in the reconstructed picture block can be slightly enhanced, thereby improving the enhancement effect on the reconstructed picture block.

In one example, if N is 1, that is, the first feature-extraction module includes one first feature-extraction unit, S404-A1 includes the following. The decoding end fuses the reconstructed picture and the quantization coefficient, and then inputs them into the first feature-extraction unit. The first feature-extraction unit performs feature extraction to extract at least one feature, and assigns different weights to features among the at least one feature according to their importance. Then, the first feature-extraction unit performs weighting on the at least one feature according to different weights to obtain the 1st feature information. Finally, the first feature information of the reconstructed picture block is determined according to the 1st feature information. For example, the 1st feature information is determined as the first feature information of the reconstructed picture block.

In another example, if N is greater than 1, that is, the first feature-extraction module includes multiple first feature-extraction units, S404-A1 includes the following. The decoding end fuses the reconstructed picture and the quantization coefficient, and then inputs them into the 1st first feature-extraction unit. The 1st first feature-extraction unit performs feature weighting, that is, extracts at least one feature and determines a weight for each of the at least one feature, and then weights the at least one feature according to the weight to obtain feature information output by the 1st first feature-extraction unit. For the convenience of description, the feature information is denoted as the 1st feature information M₁. Then, the 1st feature information Mᵢ is input into the 2nd first feature-extraction unit for feature weighting to obtain the 2nd feature information M₂, and so on. For the i-th first feature-extraction unit among the N first feature-extraction units, the (i-1)-th feature information Mᵢ₋₁ output by the (i-1)-th first feature-extraction unit is input into the i-th first feature-extraction unit for feature weighting to obtain the i-th feature information Mᵢ. Finally, the N-th feature information M_{N} output by the N-th first feature-extraction unit is obtained. The first feature information of the reconstructed picture block is determined according to the N-th feature information M_{N}. For example, the N-th feature information is determined as the first feature information of the reconstructed picture block.

The specific network structure of the first feature-extraction unit is not limited in embodiments of the disclosure. For example, the first feature-extraction unit includes at least one convolutional layer and attention mechanism.

In some embodiments, in S404-A1, the i-th feature information of the reconstructed picture block is obtained by performing feature weighting on the (i-1)-th feature information of the reconstructed picture block based on the quantization parameter as follows.

S404-A11. M feature information of different scales is extracted from the (i-1)-th feature information, where M is a positive integer greater than 1.

S404-A12. i-th weighted feature information is obtained by weighting the M feature information of different scales.

S404-A13. The i-th feature information is determined according to the i-th weighted feature information.

Specifically, the decoding end performs multi-scale feature extraction on the (i-1)-th feature information to obtain M feature information of different scales of the (i-1)-th feature information, and then performs weighting on the M feature information of different scales to obtain the i-th weighted feature information. For example, according to the importance of the feature, a larger weight is assigned to an important feature, and a smaller weight is assigned to an unimportant feature. Then, the M feature information of different scales is weighted according to weights of respective features to obtain the i-th weighted feature information of the reconstructed picture block. Finally, the i-th feature information is determined according to the i-th weighted feature information. For example, the i-th weighted feature information is determined as the i-th feature information.

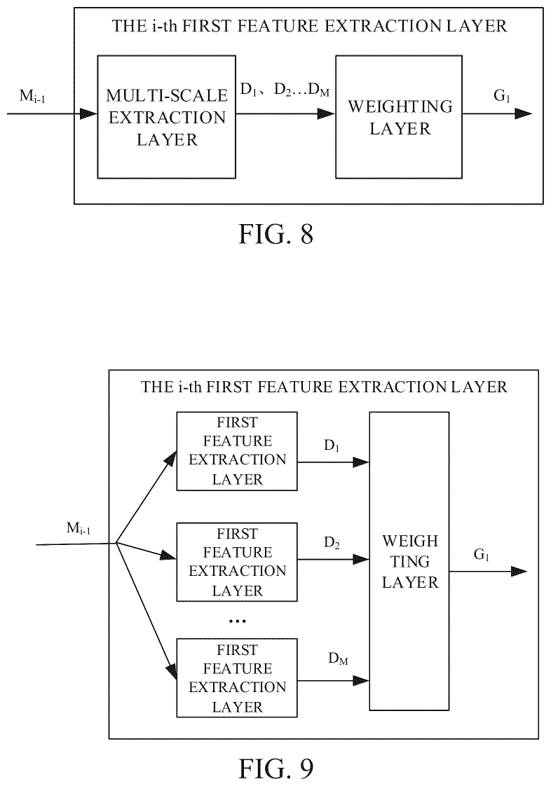

In one example, if the decoding end extracts the i-th feature information of the reconstructed picture block through the first feature-extraction unit, as illustrated in FIG. 8, the first feature-extraction unit includes a multi-scale extraction layer, where the multi-scale extraction layer is used to extract features at multiple scales.

Exemplarily, as illustrated in FIG. 8, taking the i-th first feature-extraction unit among the N first feature-extraction units as an example, the input of the i-th first feature-extraction unit is the output of the (i-1)-th first feature-extraction unit. The (i-1)-th feature information Mᵢ₋₁ output by the (i-1)-th first feature-extraction unit is input into the multi-scale extraction layer in the i-th first feature-extraction unit. The multi-scale extraction layer is used to extract features of multiple scales, for example, to extract M feature information at different scales. Next, different weights are assigned to different features in the M feature information (D₁, D₂, . . . , D_{M}) at different scales extracted by the multi-scale extraction layer, and a weighting operation is performed to obtain the i-th weighted feature information G₁. Finally, the i-th feature information Mᵢ is determined according to the i-th weighted feature information G₁. For example, the i-th weighted feature information G₁ is determined as the i-th feature information Mᵢ output by the i-th first feature-extraction unit.

As can be seen, in embodiments of the disclosure, the first feature-extraction unit performs multi-scale feature extraction to better explore the relationship between the input reconstructed picture block and the real picture block, so as to further improve the enhancement effect on the reconstructed picture block.

In some examples, the multi-scale extraction layer includes a convolution layer and a downsampling layer. For example, the convolution layer is used to output feature information, and the downsampling layer is used to downsample the feature information output by the convolution layer to obtain M feature information at different scales.

In another example, as illustrated in FIG. 9, the multi-scale extraction layer includes M first feature-extraction layers of different scales, and each first feature-extraction layer can extract feature information at a corresponding scale.

Based on FIG. 9, S404-A11 includes the following. M feature information D₁, D₂, . . . , D_{M} of different scales is extracted from the (i-1)-th feature information through the M first feature-extraction layers of different scales.

The specific network structure of the first feature-extraction layer is not limited in embodiments of the disclosure.

In some embodiments, the first feature-extraction layer includes a convolution layer, and different first feature-extraction layers include convolution layers with convolution kernels of different sizes.

For example, assume that M=2, that is, the first feature-extraction unit includes two first feature-extraction layers, and assume that the size of the convolution kernel of one first feature-extraction layer is 3×3, and the size of the convolution kernel of the other first feature-extraction layer is 5×5, the 3×3 convolution kernel and the 5×5 convolution kernel are used to perform feature extraction on the input (i-1)-th feature information Mᵢ₋₁∈ [symbol] ^{64×128×128} to obtain feature information D₁∈□^{64×128×128} and feature information D₂∈□^{64×128×128}.

In some embodiments, among the M first feature-extraction layers of different scales, at least one first feature-extraction layer includes an activation function.

According to the above, the (i-1)-th feature information is input into the multi-scale extraction layer to obtain M feature information D₁, D₂, . . . , D_{M} of different scales. Then, S404-A12 is implemented to weight the M feature information D₁, D₂, . . . , D_{M} of different scales to obtain the i-th weighted feature information G₁.

The decoding end can fuse the M feature information of different scales and perform weighting to obtain the i-th weighted feature information.

The specific manner of fusing the M feature information of different scales is not limited in embodiments of the disclosure. For example, the M feature information of different scales may be added or multiplied.

In some embodiments, S404-A12 includes the following.

S404-A12-1. First concatenated feature information is obtained by concatenating the M feature information of different scales, and the i-th weighted feature information is obtained by weighting the first concatenated feature information.

Specifically, the M feature information D₁, D₂, . . . , D_{M} of different scales are concatenated on channels to obtain the first concatenated feature information X, and X is weighted to obtain the i-th weighted feature information G1. For example, a larger weight is assigned to an important feature in X, and a smaller weight is assigned to an unimportant feature in X. Then, features in X are weighted according to weights of respective features to obtain the i-th weighted feature information G₁.

The specific implementation of weighting the M feature information of different scales to obtain the i-th weighted feature information in S404-A12 is not limited in embodiments of the disclosure.

In a possible implementation, the i-th weighted feature information is obtained by weighting the concatenated feature information in S404-A12-1 as follows.

S404-A12-11. Weighted feature information with a first number of channels is obtained by weighting the first concatenated feature information through a weighting layer.

S404-A12-12. The i-th weighted feature information is obtained according to the weighted feature information with the first number of channels.

For example, as illustrated in FIG. 8, the first feature-extraction unit further includes a weighting layer, and the weighting layer is used to perform weighting on features at multiple scales. In this way, the decoding end inputs the (i-1)-th feature information Mᵢ₋₁ output by the (i-1)-th first feature-extraction unit into the multi-scale extraction layer, for example, into M first feature-extraction layers of different scales. The M first feature-extraction layers of different scales output M feature information D₁, D₂, . . . , D_{M}. The M feature information D₁, D₂, . . . , D_{M} are concatenated and then input into the weighting layer. The weighting layer performs feature weighting on the concatenated feature information to obtain the weighted feature information \hat{X} with the first number of channels. Then, the i-th weighted feature information is obtained according to the weighted feature information \hat{X} with the first number of channels.

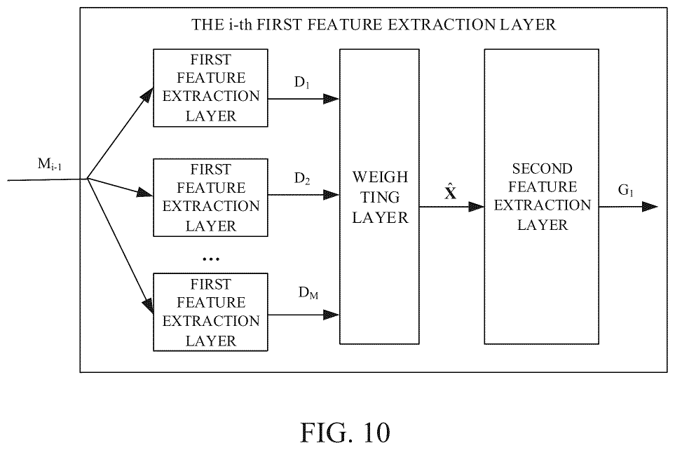

In some embodiments, since the M feature information of different scales is concatenated and then input into the weighting layer, the number of channels of the feature information output by the weighting layer may be different from the number of channels of the (i-1)-th feature information. Therefore, as illustrated in FIG. 10, in embodiments of the disclosure, the first feature-extraction unit of further includes a second feature-extraction layer. The feature-extraction layer is used to change the number of channels. In this case, the decoding end may input the weighted feature information \hat{X} with the first number of channels into the second feature-extraction layer to change the number of channels and output the i-th weighted feature information G₁.

In some embodiments, the number of channels of feature information output by each of the N first feature-extraction units may be the same. For example, the number of channels of the i-th weighted feature information is the same as the number of channels of the (i-1)-th feature information.

The specific network structure of the weighting layer is not limited in embodiments of the disclosure. Exemplarily, the weighting layer includes a neuron attention mechanism.

The network structure of the second feature-extraction layer is not limited in embodiments of the disclosure. For example, the second feature-extraction layer includes a 1×1 convolution layer.

After the i-th weighted feature information is obtained in above steps, S404-A13 is implemented to determine the i-th feature information according to the i-th weighted feature information.

In one example, the i-th weighted feature information is determined as the i-th feature information.

In another example, a sum of the i-th weighted feature information and the (i-1)-th feature information is determined as the i-th feature information.

The following introduces the network structure of the i-th first feature-extraction unit in embodiments of the disclosure by examples.

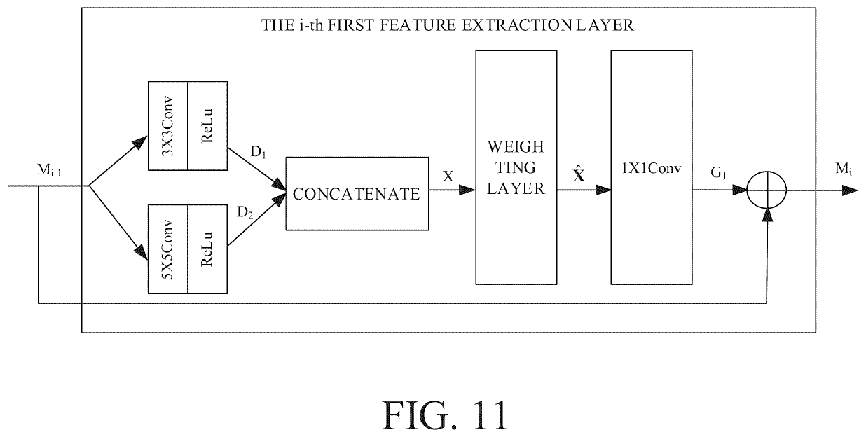

As illustrated in FIG. 11, in embodiments of the disclosure, the i-th first feature-extraction unit includes a multi-scale extraction layer, a weighting layer, and a second feature-extraction layer. The multi-scale extraction layer includes two first feature-extraction layers. The network structures of the two first feature-extraction layers are basically the same. The two first feature-extraction layers each include a convolution layer and an activation function. However, the sizes of convolution kernels included in the two first feature-extraction layers are different. One convolution kernel has a size of 3×3, and the other convolution kernel has a size of 5×5. Exemplarily, the activation function included in the two first feature-extraction layers is ReLu. It should be noted that, the activation function can also be activation functions in other forms. The second feature-extraction layer includes a convolution layer with a convolution kernel of size 1×1 to reduce the number of feature channels.

Specifically, as illustrated in FIG. 11, the (i-1)-th feature information Mᵢ₋₁∈ [symbol] ^{64×128×128} output by the (i-1)-th first feature-extraction unit is respectively input into the two first feature-extraction layers. The two first feature-extraction layers perform multi-scale feature extraction and output feature information D₁∈□^{64×128×128} and feature information D₂∈□^{64×128×128}. Then, the feature information D₁∈□^{64×128×128} and feature information D₂∈ [symbol] ^{64×128×128} are concatenated to obtain the first concatenated feature information X∈ [symbol] ^{128×128×128}.

Exemplarily, the feature information C₁, C₂, and X are determined by the following formula (1):

$$\{ \begin{matrix}{D}_{1} ( {M}_{i - 1} ) = σ ( {W}_{1} ⋆ {M}_{i - 1} ) \\ {D}_{2} ( {M}_{i - 1} ) = σ ( {W}_{2} ⋆ {M}_{i - 1} ) \\ X = [ {D}_{1} ( {M}_{i - 1} ) , {D}_{2} ( {M}_{i - 1} ) ]\end{matrix} \qquad ( 1 )$$

where σ represents the ReLU activation function, W₁ and W₂ represent a 3×3 convolution kernel and a 5×5 convolution kernel, respectively, and * represents the convolution operation. It should be noted that the size of the convolution kernel and the type of the activation function can be changed according to actual needs.

Next, the first concatenated feature information X∈□^{128×128×128} is input into the weighting layer for feature weighting. Specifically, a larger weight is assigned to an important feature to enhance the influence of the feature, and a smaller weight is assigned to an unimportant feature to weaken the influence of the feature. The weighting layer outputs weighted feature information \hat{X}∈□^{128×128×128} with a first number of channels. The feature information \hat{X}∈□^{128×128×128} is then input into the second feature-extraction layer to reduce the number of feature channels. Specifically, a 1×1 convolution operation is performed on x to obtain the i-th weighted feature information D₃∈ [symbol] ^{64×128×128}, so as to reduce the number of feature channels. D₃ is added to the input Mᵢ₋₁ to obtain the i-th feature information Mᵢ∈□^{64×128×128} output by the i-th first feature-extraction unit.

Exemplarily, the feature information D₃ and Mᵢ₋₁ are determined by the following formula (2):

$$\{ \begin{matrix}{D}_{3} = σ ( {W}_{3} * \hat{X} ) \\ {M}_{i} = {D}_{3} + {M}_{i - 1}\end{matrix} \qquad ( 2 )$$

where σ represents the ReLU activation function, W₃ represents a 1×1 convolution kernel, and * represents the convolution operation. It should be noted that the size of the convolution kernel and the type of the activation function can be changed according to actual needs.

The specific network structure of the weighting layer is not limited in embodiments of the disclosure.

In some embodiments, the weighting layer includes a neuron attention mechanism.

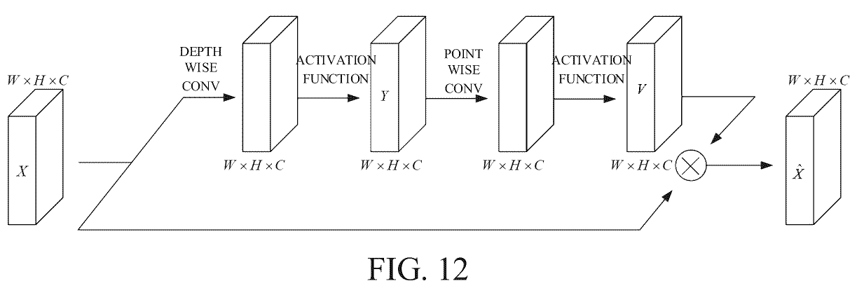

Exemplarily, the network structure of the neuron attention mechanism is as illustrated in FIG. 12, which includes a depth wise convolution, a point wise convolution, and activation functions. Specifically, the concatenated feature X is convolved on different channels through the depth wise convolution operation, and then subjected to the ReLU activation function and then the point wise convolution operation, so that information of different feature maps is fused. Then, a weight feature map V∈□^{128×128×128} is obtained through a Sigmoid activation function, and V is multiplied by X element by element to obtain the weighted feature information \hat{X}∈□^{128×128×128} with the first number of channels.

Exemplarily, the weighted feature information \hat{X} with the first number of channels may be determined by the following formula (3):

$$\{ \begin{matrix}{Y}_{c} = σ ( {W}_{d} ( {X}_{c} ) ) \\ V = δ ( {W}_{p} ( Y ) ) \\ \hat{X} = V ⊗ X\end{matrix} \qquad ( 3 )$$

where Y_{c} represents a feature of feature information Y on one channel, X_{c} represents a feature of feature information X on one channel, σ represents the ReLU activation function, δ represents the Sigmoid activation function, W_{d} and Wₚ represents depth wise convolution and point wise convolution respectively, and ⊗ represents an element-wise multiplication operation. It should be noted that, the type of the activation function can be changed according to actual needs.

After the weighted feature information \hat{X} having the first number of channels is determined according to formula (3), \hat{X} is substituted into formula (2) to determine the i-th feature information Mᵢ.

In the above, the extraction of the i-th feature information by the i-th first feature-extraction unit among the N first feature-extraction units is taken as an example. For other first feature-extraction units among the N first feature-extraction units, reference can be made to the extraction of the i-th feature information by the i-th first feature-extraction unit. As such, finally, the N-th feature information can be extracted by the N-th first feature-extraction unit.

Next, S404-A2 is implemented to determine the first feature information of the reconstructed picture block according to the N-th feature information.

The implementation manner of S404-A2 includes but is not limited to the following.

Manner 1. The N-th feature information is determined as the first feature information of the reconstructed picture block.

Manner 2. S404-A2 includes S404-A2-1: the first feature information of the reconstructed picture block is obtained according to the N-th feature information and at least one of first N-1 feature information prior to the N-th feature information.

As can be seen, the decoding end performs N iterative feature weighting on the reconstructed picture block based on the quantization parameter. For example, the i-th feature information of the reconstructed picture block is obtained by performing feature weighting on the (i-1)-th feature information of the reconstructed picture block based on the quantization parameter, where i is a positive integer from 1 to N, and the N-th feature information of the reconstructed picture block is obtained by repeating feature weighting. As such, in order to improve the accuracy of obtaining the first feature information, the decoding end can obtain the first feature information of the reconstructed picture block based on the N-th feature information and at least one of the first N-1 feature information prior to the N-th feature information. For example, the at least one of the first N-1 feature information is concatenated with the N-th feature information, and then feature extraction is performed to obtain the first feature information of the reconstructed picture block.

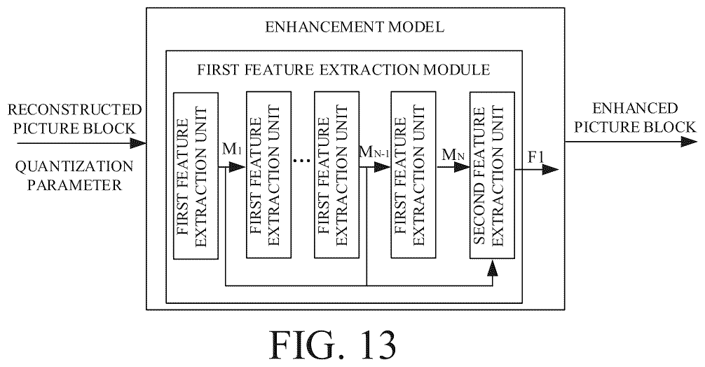

In some embodiments, as illustrated in FIG. 13, the first feature-extraction module includes, in addition to N first feature-extraction units, a second feature-extraction unit. The second feature-extraction unit is configured to perform feature extraction on feature information output by at least one of the first N-1 first feature-extraction units and the N-th feature information output by the N-th first feature-extraction unit, so as to obtain deeper feature information. Specifically, in order to prevent the loss of features of the reconstructed picture block of the current picture block as the network goes deeper, the decoding end inputs feature information output by at least one of the first N-1 first feature-extraction modules among the N first feature-extraction modules and the N-th feature information M_{N} output by the N-th first feature-extraction module into the second feature-extraction unit. For example, feature information output by at least one of the first N-1 first feature-extraction modules is concatenated with the N-th feature information M_{N} and then input into the second feature-extraction unit. The second feature-extraction unit performs deeper feature extraction to obtain the first feature information F1 of the reconstructed picture block.

In some embodiments, S404-A2-1 also includes the following. Feature information output by at least one first feature-extraction module among the first N-1 first feature-extraction modules, the N-th feature information, the reconstructed picture block, and the quantization parameter are concatenated and then input into the second feature-extraction unit to obtain the first feature information of the reconstructed picture block.

In this embodiment, in order to further generate the first feature information satisfying requirements, the reconstructed picture block and the quantization parameter, together with the feature information output by the at least one first feature-extraction module and the N-th feature information, are input into the second feature-extraction unit for feature extraction, so that the feature extraction is supervised by the reconstructed picture block and the quantization parameter, and the first feature information output better meets the requirements.

In some embodiments, in order to improve the accuracy of determining the first feature information of the reconstructed picture block, in embodiments of the disclosure, shallow feature information (i.e., second feature information) of the reconstructed picture block is first extracted, and then the first feature information of the reconstructed picture block is determined based on the second feature information.

Based on this, S404-A includes the following. Second feature information of the reconstructed picture block is extracted based on the quantization parameter. The first feature information of the reconstructed picture block is obtained by performing feature weighting on the second feature information.

Specifically, shallow feature extraction is performed on the reconstructed picture block based on the quantization parameter to obtain the second feature information of the reconstructed picture block. For example, concatenated information is obtained by concatenating the reconstructed picture block and the quantization parameter, and the second feature information of the reconstructed picture block is obtained by performing shallow feature extraction on the concatenated information. Then, the first feature information of the reconstructed picture block is determined based on the second feature information. For example, deep feature extraction is performed based on the second feature information to obtain the first feature information of the reconstructed picture block.

The specific manner of performing feature extraction on the concatenated information to obtain the second feature information is not limited in embodiments of the disclosure.

In a possible implementation, the second feature information is obtained by performing feature extraction on the concatenated information through a second feature-extraction module.

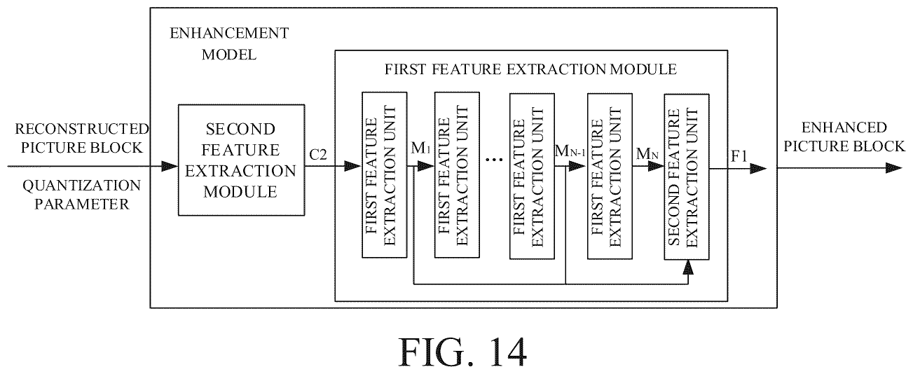

For example, as illustrated in FIG. 14, in embodiments of the disclosure, the enhancement model includes, in addition to the first feature-extraction module, a second feature-extraction module. The second feature-extraction module is configured to extract shallow feature information of the reconstructed picture block, and input the extracted shallow feature information into the first feature-extraction module for deep feature extraction. Specifically, as illustrated in FIG. 14, the decoding end first concatenates the reconstructed picture and the quantization parameter to obtain concatenated information, and then inputs the concatenated information into the second feature-extraction module for shallow feature extraction, to obtain the second feature information C2 of the reconstructed picture block. Then, the shallow second feature information C2 is input into the first feature-extraction module to obtain the first feature information F1 of the reconstructed picture block.

In this case, in some embodiments, S404-A2-1 includes the following. Second concatenated feature information is obtained by concatenating the at least one of the first N-1 feature information, the N-th feature information, and the second feature information. The first feature information of the reconstructed picture block is obtained by performing feature extraction on the second concatenated feature information.

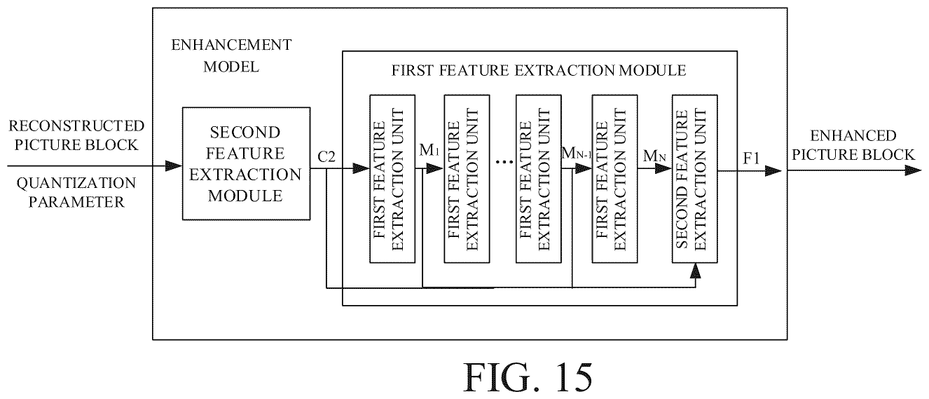

Exemplarily, as illustrated in FIG. 15, feature information output by at least one of the first N-1 first feature-extraction modules, the N-th feature information M_{N}, and the second feature information C2 are concatenated and then input into the second feature-extraction unit to obtain the first feature information F1 of the reconstructed picture block.

The specific network structure of the second feature-extraction module is not limited in embodiments of the disclosure.

In one example, the second feature-extraction module includes at least one convolutional layer.

Exemplarily, if the second feature-extraction module includes two convolutional layers, the decoding end obtains the second feature information of the reconstructed picture block through the two convolutional layers.

The following introduces the determination of the second feature information by taking the second feature-extraction module including two convolutional layers as an example.

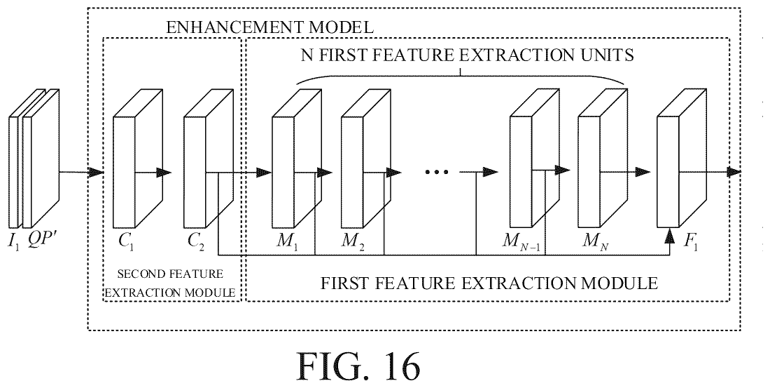

For example, as illustrated in FIG. 16, the decoding end normalizes the reconstructed picture block to obtain a normalized reconstructed picture block I₁∈ [symbol] ^{1×128×128}. Similarly, the decoding end normalizes the quantization parameter to obtain a normalized quantization parameter QP′∈□^{1×128×128}. Then, I₁∈ [symbol] ^{1×128×128} and QP′∈□^{1×128×128} are concatenated and then input into the second feature-extraction module. The first convolution layer outputs the feature C₁∈ [symbol] ^{64×128×128}. The feature C₁ is input into the second convolution layer. The second convolution layer outputs the second feature information C₂∈ [symbol] ^{64×128×128}.

In an example, the second feature information C2 can be determined by the following formula (4):

$$\{ \begin{matrix}{C}_{1} ( {I}_{1} ) = σ ( {W}_{1} ⋆ ( {I}_{1} \cdot QP ) ) \\ {C}_{2} ( {I}_{1} ) = σ ( {W}_{2} ⋆ {C}_{1} ( {I}_{1} \cdot QP ) )\end{matrix} \qquad ( 4 )$$

where σ represents the ReLU activation function, W₁ and W₂ represent 3×3 convolution kernels, * represents the convolution operation, and [symbol] represents the concatenation operation. It should be noted that the size of the convolution kernel and the type of the activation function can be changed according to actual needs.

According to the above, after the second feature information of the reconstructed picture block is determined, the second feature information is subjected to feature weighting to obtain the first feature information of the reconstructed picture block. The enhanced picture block of the reconstructed picture block is determined according to the first feature information of the reconstructed picture block.

The specific manner of determining the enhanced picture block of the reconstructed picture block according to the first feature information of the reconstructed picture block in S404-B is not limited in embodiments of the disclosure.

In some embodiments, if the first feature information of the reconstructed picture block is consistent with the reconstructed picture block in terms of the size, the first feature information may be determined as the enhanced picture block.

In some embodiments, S404-B includes the following. The enhanced picture block is obtained by performing nonlinear mapping on the first feature information of the reconstructed picture block.

The specific manner of performing nonlinear mapping on the first feature information of the reconstructed picture block to obtain the enhanced picture block in S404-B is not limited in embodiments of the disclosure.

For example, the first feature information of the reconstructed picture block is processed in a nonlinear mapping manner, so that the size of the processed first feature information of the reconstructed picture block is consistent with the size of the reconstructed picture block, and then the processed first feature information of the reconstructed picture block is used as the enhanced picture block.

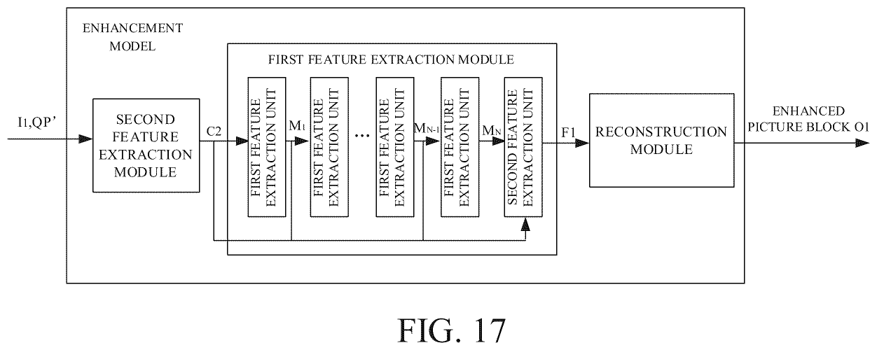

In some embodiments, as illustrated in FIG. 17, in embodiments of the disclosure, the enhancement model further includes a reconstruction module. The reconstruction module is configured to perform further nonlinear mapping on the first feature information extracted by the first feature-extraction module.

Based on FIG. 17, S404-B includes the following. The enhanced picture block is obtained by performing nonlinear mapping on the first feature information of the reconstructed picture block through a reconstruction module.

The network model of the reconstruction module is not limited in embodiments of the disclosure.

In some embodiments, the reconstruction module includes at least one convolutional layer.

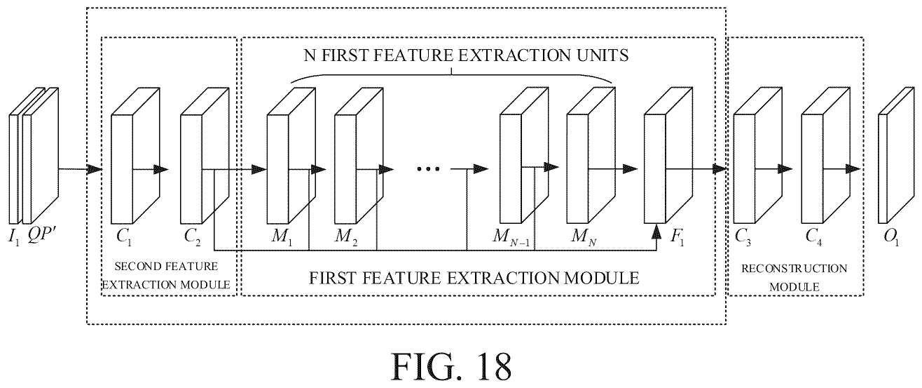

Exemplarily, as illustrated in FIG. 18, the reconstruction module includes two convolutional layers. The encoding end inputs the first feature information F1 of the reconstructed picture block output by the first feature-extraction module into the reconstruction module. After convolution operations at the two convolutional layers, the enhanced picture block O1 of the reconstructed picture block is obtained.

In one example, the enhanced picture block O1 can be determined by the following formula (5):

$$\{ \begin{matrix}{C}_{3} ( {I}_{1} ) = σ ( {W}_{3} ⋆ {F}_{1} ) \\ {C}_{4} ( {I}_{1} ) = σ ( {W}_{4} ⋆ {C}_{3} ( {I}_{1} ) ) \\ {O}_{1} ( {I}_{1} ) = σ ( {W}_{5} ⋆ {C}_{4} ( {I}_{1} ) )\end{matrix} \qquad ( 5 )$$

where F1 represents the first feature information of the reconstructed picture, σ represents the ReLU activation function, W₃, W₄, and W₅ represent 3×3 convolution kernels, and * represent the convolution operation. It should be noted that the size of the convolution kernel and the type of the activation function can be changed according to actual needs.

In embodiments of the disclosure, the decoding end performs quality enhancement on the reconstructed picture block based on the quantization parameter through the above steps to obtain the enhanced picture block of the reconstructed picture block.

In some embodiments, before performing quality enhancement on the reconstructed picture block, the decoding end needs to determine whether quality enhancement on the reconstructed picture block is allowed. In other words, the decoding end performs quality enhancement on the reconstructed picture block when determining that quality enhancement on the reconstructed picture block provides better effect than no quality enhancement.

The manner in which the decoding end determines whether quality enhancement is allowed for the reconstructed picture block includes but is not limited to the following.

Manner 1. The bitstream is decoded to obtain a first flag, where the first flag indicates whether quality enhancement is allowed for the reconstructed picture block of the current picture block.

In manner 1, the encoding end determines whether to perform quality enhancement on the reconstructed picture block of the current picture block, and notifies the decoding end of the determination result of the encoding end through the first flag, so that the decoding end and the encoding end adopt a consistent picture enhancement strategy. Specifically, if the encoding end performs quality enhancement on the reconstructed picture block of the current picture block, the value of the first flag is set to a first value, for example, 1. If the encoding end does not perform quality enhancement on the reconstructed picture block of the current picture block, the value of the first flag is set to a second value, for example, 0. In this way, the decoding end first decodes the bitstream to obtain the first flag, and determines whether quality enhancement is allowed for the reconstructed picture block of the current picture block according to the first flag. For example, if the value of the first flag is 1, the decoding end determines to perform quality enhancement on the reconstructed picture block using the method in embodiments of the disclosure, that is, perform quality enhancement on the reconstructed picture block based on the quantization coefficient. If the value of the first flag is 0, the decoding end determines not to perform quality enhancement on the reconstructed picture block, but to filter the reconstructed picture block using an existing in-loop filtering method.

Optionally, the first flag may be a sequence-level flag.

Optionally, the first flag may be a frame-level flag.

Optionally, the first flag may be a slice-level flag.

Optionally, the first flag may be a block-level flag, such as a CTU-level flag or a CU-level flag.

Manner 2. The decoding end determines on its own whether to perform quality enhancement on the reconstructed picture block.

Specifically, the decoding end first performs quality enhancement on the reconstructed picture block based on the quantization parameter to obtain a test enhanced picture block. Then, the decoding end determines the picture quality corresponding to the test enhanced picture block and the picture quality corresponding to the unenhanced reconstructed picture block. If the picture quality of the test enhanced picture block is greater than the picture quality of the reconstructed picture block, it means that the enhancement method in embodiments of the disclosure can achieve a significant enhancement effect. In this case, the decoding end determines the determined test enhanced picture block as the enhanced picture block of the reconstructed picture block for direct output for display, and/or saves the determined test enhanced picture block in the decoded picture buffer as an intra-frame reference for subsequent picture blocks.

If the picture quality of the test enhanced picture block is less than or equal to the picture quality of the reconstructed picture block, it means that the enhancement method in embodiments of the disclosure cannot achieve a significant enhancement effect. In this case, the reconstructed picture block is directly output for display after being in-loop filtered, and/or the in-loop filtered reconstructed picture block is saved in the decoded picture buffer as an intra-frame reference for subsequent picture blocks.

The method of determining the picture quality is not limited in embodiments of the disclosure. For example, the peak signal-to-noise ratio (PSNR) or the structural similarity (SSIN) is used as a metric to evaluate the picture quality.

In some embodiments, the reconstructed picture block is a reconstructed picture block subjected to in-loop filtering. For example, the decoding end determines a prediction block of the current picture block and a residual block of the current picture block, and adds the residual block to the prediction block to obtain the reconstructed picture block. The reconstructed picture block is then filtered by an in-loop filter, and the filtered reconstructed picture block is input into the enhancement model for quality enhancement.

In some embodiments, in embodiments of the disclosure, the reconstructed picture block may be subjected to quality enhancement by the enhancement model, and then in-loop filtering.

In some embodiments, in embodiments of the disclosure, the reconstructed picture block is subjected to quality enhancement by the enhancement model, but no further in-loop filtering.

In some embodiments, in embodiments of the disclosure, after the enhancement model performs quality enhancement on the reconstructed picture block, the enhanced picture block may be displayed and stored in the decoded picture buffer as a reference for other picture blocks.

Optionally, the decoding end may display the enhanced picture block and store the unenhanced reconstructed picture block in the decoded picture buffer as a reference for other picture blocks.

Optionally, the decoding end may display the reconstructed picture block and store the enhanced picture block in the decoded picture buffer as a reference for other picture blocks.

It should be noted that before being used for quality enhancement, the enhancement model needs to be trained first.

In some embodiments, the training of the enhancement model may be completed by other devices, and the decoding end can directly use the trained enhancement model for quality enhancement.

In some embodiments, the training of the enhancement model may be completed by the decoding end. For example, the decoding end trains the enhancement model using training data, and uses the trained enhancement model for quality enhancement.

In some embodiments, a training set for the enhancement model consists of 800 pictures for training in a super-resolution reconstruction DIV2K data set. With a configuration of the QP set to 22,27,32,37, the AI mode, and the in-loop filtering, i.e., the luma mapping with chroma scaling (LMCS), the deblocking filter (DB), the sample adaptive offset (SAO), and the adaptive loop filter (ALF) off, these 800 pictures are encoded using a versatile video coding and test model 8.2 (VTM8.2), i.e., a VVC test platform version 8.2, to obtain a total of 3200 encoded pictures. These 3200 encoded pictures are used as the input of the network model, and the corresponding un-encoded original pictures are taken as true values, thereby constituting the final training set.

Optionally, in order to increase the diversity of the data set, during the loading of the training set, a picture block of size 128×128 is cropped randomly from each picture in a random cropping manner as the input of the enhancement model.

Optionally, an initial learning rate of the enhancement model is set to 1×10⁻², and the learning rate is reduced to ½ of the original learning rate every 30 epochs. For example, the training is finally completed on a Pytorch 1.6.0 platform.

According to the method for picture processing provided in embodiments of the disclosure, the bitstream is decoded to obtain the quantization coefficient of the current picture block, the quantization parameter corresponding to the current picture block is determined, and the transform coefficient of the current picture block is obtained by performing inverse quantization on the quantization coefficient based on the quantization parameter, the reconstructed picture block of the current picture block is determined according to the transform coefficient, and the enhanced picture block is obtained by performing quality enhancement on the reconstructed picture block based on the quantization parameter. Different picture blocks may correspond to different quantization coefficients. Therefore, in the disclosure, to improve the accuracy of the enhancement of the picture block, quality enhancement is performed on the reconstructed picture block based on the quantization coefficient, thereby improving the enhancement effect. In addition, in the disclosure, picture quality enhancement is performed in units of picture blocks, so that when the enhanced picture block is used as a reference block for other picture blocks in intra prediction, a more accurate reference can be provided, thereby improving the accuracy of intra prediction.

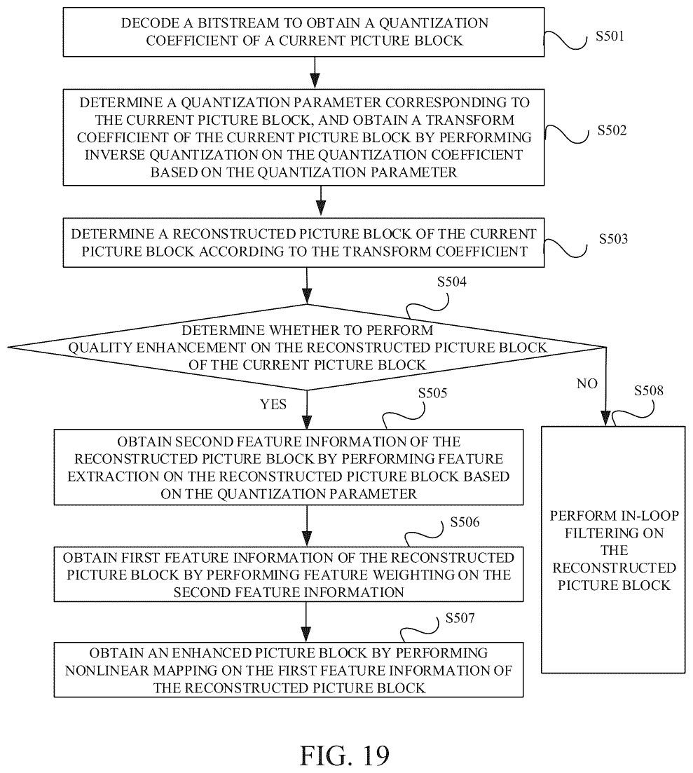

FIG. 19 is a schematic flowchart of a method for picture processing provided in embodiments of the disclosure. FIG. 19 can be understood as a more specific method with respect to the method for picture processing illustrated in FIG. 4. As illustrated in FIG. 19, the method for picture processing in embodiments of the disclosure includes the following.

S501. A bitstream is decoded to obtain a quantization coefficient of a current picture block.

S502. A quantization parameter corresponding to the current picture block is determined, and a transform coefficient of the current picture block is obtained by performing inverse quantization on the quantization coefficient based on the quantization parameter.

S503. A reconstructed picture block of the current picture block is determined according to the transform coefficient.

The specific implementation of S501 to S503 may refer to the description of S401 to S403, which will not be repeated herein.

S504. Whether to perform quality enhancement on the reconstructed picture block of the current picture block is determined.

Manner 1. The bitstream is decoded to obtain a first flag, and whether quality enhancement is allowed for the reconstructed picture block of the current picture block is determined according to the first flag.

Manner 2. The decoding end performs quality enhancement on the reconstructed picture block based on the quantization parameter to obtain a test enhanced picture block, determines a first picture quality of the test enhanced picture block and a second picture quality of the reconstructed picture block, and determines whether to perform quality enhancement on the reconstructed picture block of the current picture block based on the first picture quality and the second picture quality.

If the decoding end determines to perform quality enhancement on the reconstructed picture block of the current picture block, the following S505 is implemented.

If the decoding end determines not to perform quality enhancement on the reconstructed picture block of the current picture block, the following S508 is implemented.

S505. Second feature information of the reconstructed picture block is obtained by performing feature extraction on the reconstructed picture block based on the quantization parameter.

S506. First feature information of the reconstructed picture block is obtained by performing feature weighting on the second feature information.

S507. An enhanced picture block is obtained by performing nonlinear mapping on the first feature information of the reconstructed picture block.

In some embodiments, the enhanced picture block is obtained by performing quality enhancement on the reconstructed picture block using an enhancement model.

Exemplarily, as illustrated in FIG. 18, in embodiments of the disclosure, the enhancement model includes a second feature-extraction module, a first feature-extraction module, and a reconstruction module. The second feature-extraction module is configured to extract shallow features (i.e., the second feature information of the reconstructed picture block). The first feature-extraction module is configured to extract deep features (i.e., the first feature information of the reconstructed picture block). The reconstruction module is configured to perform nonlinear mapping on the deep features to obtain the final enhanced picture block.

Exemplarily, the second feature-extraction module illustrated in FIG. 18 includes two convolutional layers. However, the structure of the second feature-extraction module provided in embodiments of the disclosure includes but is not limited to that illustrated in FIG. 18.

Exemplarily, as illustrated in FIG. 18, the first feature-extraction module includes N first feature-extraction layers and one second feature-extraction layer. The N first feature-extraction layers are connected in series. Both the outputs of the N first feature-extraction layers and the output of the second feature-extraction module are input into the second feature-extraction layer. However, the network structure of the first feature-extraction module provided in embodiments of the disclosure includes but is not limited to that illustrated in FIG. 18.

Exemplarily, as illustrated in FIG. 18, the reconstruction module includes two convolutional layers. However, the network structure of the reconstruction module provided in embodiments of the disclosure includes but is not limited to that illustrated in FIG. 18.

In some embodiments, the first feature-extraction layer in embodiments of the disclosure includes a multi-scale extraction layer and a neuron attention mechanism. The multi-scale extraction layer is used to perform multi-scale feature extraction. The neuron attention mechanism is used for feature weighting. In this case, the first feature-extraction layer in embodiments of the disclosure may also be referred to as a multi-scale and neuron attention (MSNA) unit.

In some embodiments, the enhancement model in embodiments of the disclosure is also referred to as a neuron attention-based CNN (NACNN).

Specifically, as illustrated in FIG. 18, the decoding end performs normalization and then concatenation on the reconstructed picture block and the quantization parameter, and inputs the concatenation result into the enhancement model. The first convolution layer in the second feature-extraction module performs a convolution operation on the reconstructed picture block and the quantization parameter to obtain feature information C1, and then inputs the feature information C1 into the second convolution layer for convolution to obtain second feature information C2. The decoding end inputs the second feature information C2 into the first feature-extraction module, and the 1st first feature-extraction unit in the first feature-extraction module performs multi-scale feature extraction and feature weighting on C2 to obtain the 1st feature information M1. Next, the 1st feature information M1 is input into the 2nd first feature-extraction unit for multi-scale feature extraction and feature weighting to obtain the 2nd feature information M2. By analogy, the N-th feature information MN output by the N-th first feature-extraction unit is obtained. At the decoding end, the N feature information M1, M2, . . . , MN extracted by respective layers in the first feature-extraction module and the second feature information C2 output by the second feature module are concatenated and then input into the second feature-extraction layer in the first feature-extraction module to change the number of channels and output the first feature information F1 of the reconstructed picture block. Then, the decoding end inputs the first feature information F1 into the reconstruction module for reconstruction. Specifically, the first convolution layer in the reconstruction module performs a convolution operation to obtain feature information C3, and the second convolution layer in the reconstruction module performs a convolution operation on the feature information C3 to obtain feature information C4. Finally, the enhanced picture block O1 of the reconstructed picture block is obtained according to the feature information C4. For example, the feature information C4 is output as the enhanced picture block O1 of the reconstructed picture block.

It should be noted that the specific implementation of S505 to S507 may refer to the specific description of S404, which will not be repeated herein.

S508. In-loop filtering is performed on the reconstructed picture block.

In some embodiments, if the decoding end determines not to perform quality enhancement on the reconstructed picture block of the current picture block using the enhancement model, S508 is implemented to perform in-loop filtering on the reconstructed picture block.

According to the method for picture processing provided in embodiments of the disclosure, before performing quality enhancement on the reconstructed picture block, the decoding end first determines whether to perform quality enhancement on the reconstructed picture block, thereby improving the reliability of picture processing.

The above introduces the method for picture processing in embodiments of the disclosure by taking the decoding end as an example. On this basis, the following introduces the method for picture processing provided in embodiments of the disclosure by taking the encoding end as an example.

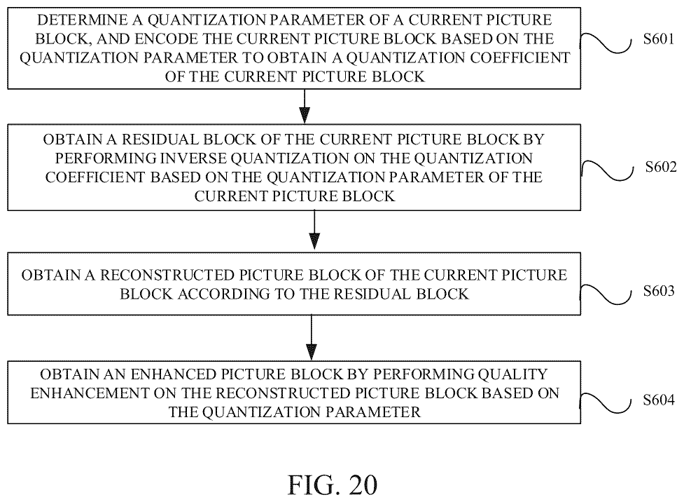

FIG. 20 is a schematic flowchart of a method for picture processing provided in embodiments of the disclosure, and embodiments of the disclosure is applicable to the encoder illustrated in FIGS. 1 and 2. As illustrated in FIG. 20, the method in embodiments of the disclosure includes the following.

S601. A quantization parameter of a current picture block is determined, and the current picture block is encoded based on the quantization parameter to obtain a quantization coefficient of the current picture block.

S602. A residual block of the current picture block is obtained by performing inverse quantization on the quantization coefficient based on the quantization parameter of the current picture block.

S603. A reconstructed picture block of the current picture block is obtained according to the residual block.

During picture encoding, the encoder receives a video stream consisting of a series of pictures and performs video encoding on each picture in the video stream. The video encoder divides the picture into blocks to obtain a current encoding block.

The specific size of the current picture block is not limited in embodiments of the disclosure.

In some embodiments, the current picture block in embodiments of the disclosure is a CTU. For example, one picture is divided into several CTUs. The size of the CTU is not limited in the disclosure. For example, the size of the CTU may be 128×128, 64×64, 32×32, etc.

In some embodiments, the current picture block in embodiments of the disclosure is a CU. For example, one CTU is divided into one or more CUs.

In some embodiments, the current picture block in embodiments of the disclosure is a TU or a PU. For example, one CU is divided into one or more TUs or PUs.

In some embodiments, the current picture block in embodiments of the disclosure only includes a chroma component and can be understood as a chroma block.

In some embodiments, the current picture block in embodiments of the disclosure only includes a luma component and can be understood as a luma block.

In some embodiments, the current picture block includes both a luma component and a chroma component.

In some embodiments, if the current picture block includes a CU, the encoding process in embodiments of the disclosure includes the following. The current picture is divided into blocks to obtain the current picture block. The current picture block is predicted in an intra prediction manner or an inter prediction manner to obtain a prediction value of the current picture block. An original value of the current picture block is subtracted by the prediction value of the current picture block to obtain a residual value of the current picture block. A transform manner corresponding to the current picture block is determined. The residual value is transformed in the transform manner to obtain a transform coefficient. The transform coefficient is quantized using the determined quantization parameter to obtain the quantization coefficient. The quantization coefficient is encoded to obtain a bitstream.

In addition, the encoding end also involves a decoding process which specifically includes the following. As illustrated in FIG. 2, an inverse quantization/transform unit 240 performs inverse quantization on the quantization coefficient based on the determined quantization parameter to obtain the transform coefficient, and then performs inverse transform on the transform coefficient to obtain a residual block. The reconstruction unit 250 adds the prediction block and the residual block to obtain a reconstructed picture block of the current picture block.

In some embodiments, if the current picture block includes multiple CUs, the encoding end divides the current picture into blocks to obtain multiple CUs. For each CU, a reconstructed block of the CU may be obtained according to the above method. In this way, the reconstructed blocks of the CUs included in the current picture block are combined to obtain a reconstructed picture block of the current picture block.

It should be noted that, if the current picture block includes multiple CUs, the quantization parameter of the current picture block includes quantization parameters corresponding to the multiple CUs. Optionally, the quantization parameters corresponding to the multiple CUs may be the same or different.

In a possible implementation, the quantization parameter of the current picture block in embodiments of the disclosure may be in the form of a matrix. For example, if the size of the current picture block is 16×16, the quantization parameter of the current picture block may be a 16×16 matrix, and each element in the matrix is the quantization parameter of the pixel at the corresponding position in the current picture block.

The specific process of determining the quantization parameter corresponding to the current picture block is not limited in embodiments of the disclosure.

In some embodiments, the encoding end and the decoding end use a default quantization parameter as the quantization parameter corresponding to the current picture block.

In some embodiments, the encoding end determines the quantization parameter corresponding to the current picture block through calculation. Optionally, in this case, the encoding end may signal the determined quantization parameter in the bitstream, so that the decoding end can determine the quantization parameter corresponding to the current picture block by decoding the bitstream.

S604. An enhanced picture block is obtained by performing quality enhancement on the reconstructed picture block based on the quantization parameter.

During video encoding, different picture blocks may correspond to different quantization parameters (QPs). In some embodiments, the QP includes a quantization step size. During video encoding, the transform coefficient of the picture block is quantized. The larger the quantization step size, the more the picture loss, and the smaller the quantization step size, the less the picture loss. Therefore, in order to improve the enhancement effect on the current picture block, in embodiments of the disclosure, during quality enhancement of the current picture block, the influence of the QP corresponding to the current picture block is considered.

Different quantization coefficients result in different losses during inverse quantization of a picture block, in order to improve the enhancement effect on the picture block, in embodiments of the disclosure, quality enhancement is performed on the reconstructed picture block of the current picture block based on the quantization coefficient corresponding to the current picture block, thereby improving the enhancement effect on the reconstructed picture block.

In embodiments of the disclosure, picture quality enhancement is performed in units of picture blocks, so that when an enhanced picture block is used as a reference block for other picture blocks in intra prediction, a more accurate reference can be provided, thereby improving the accuracy of intra prediction.

In addition, in embodiments of the disclosure, picture quality enhancement is performed in units of picture blocks. As such, compared with performing picture quality enhancement on a picture as a whole, more emphasis can be placed on enhancement on finer features in picture blocks, thereby further improving the enhancement quality of the picture block.

In embodiments of the disclosure, the manner for obtaining the enhanced picture block by performing quality enhancement on the reconstructed picture block based on the quantization parameter is not limited.

In an embodiment, the encoding end performs quality enhancement on the reconstructed picture block through an enhancement model based on the quantization parameter to obtain the enhanced picture block. Specifically, after determining the reconstructed picture block of the current picture block in above steps, in order to reduce the distortion of the reconstructed picture block and improve the quality of the reconstructed picture block, as illustrated in FIG. 5, in order to reduce the distortion of the reconstructed picture block and improve the quality of the reconstructed picture block, as illustrated in FIG. 5, the encoding end inputs the reconstructed picture block and the corresponding quantization coefficient into the pre-trained enhancement model for picture enhancement, and finally obtains the enhanced picture block of the current picture block. It should be noted that, the enhancement model is trained based on different picture blocks and their corresponding quantization parameters, and fully learns the influence of quantization parameters on quality enhancement of picture blocks, and thus can perform, based on different quantization parameters, better quality enhancement on reconstructed picture blocks obtained after inverse quantization based on these different quantization parameters. The enhancement model in embodiments of the disclosure may be any neural network model that can perform quality enhancement on the picture block. The specific network model of the enhancement model is not limited in embodiments of the disclosure.

In some embodiments, at the encoding end, the reconstructed picture block and the quantization parameter are fused and then input into the enhancement model. The fusion manner of the reconstructed picture block and the quantization parameter includes at least the following examples.

Example 1. Assume that the size of the reconstructed picture block is N1*N2, where N1 and N2 can be the same or different. The reconstructed picture block is multiplied by the quantization parameter and then input into the enhancement model. Specifically, each pixel of the reconstructed picture block is multiplied by the quantization parameter to obtain a matrix of N1*N2, and the matrix is input into the enhancement model.

Example 2. The reconstructed picture and the quantization parameter are concatenated and then input into the enhancement model. Specifically, the quantization coefficient is set as a matrix of N1*N2, and the reconstructed picture of N1*N2 and the quantization parameter of N1*N2 are concatenated and then input into the enhancement model.

It should be noted that, in addition to the fusion manners illustrated in Examples 1 and 2 above, the encoding end may also fuse the reconstructed picture and the corresponding quantization parameter in other fusion manners and then input them into the enhancement model for quality enhancement.

In some embodiments, in order to prevent features with smaller absolute values from being covered by features with larger absolute values, the reconstructed picture block and quantization parameter are normalized by the encoding end before input into the enhancement model, so that all features are treated equally. Then, based on the normalized reconstructed picture block and quantization parameter, the enhanced picture block of the reconstructed picture blocks is obtained. For example, the normalized reconstructed picture block and quantization parameter are concatenated and then input into the enhancement model for quality enhancement, so as to improve the effect of quality enhancement.

In embodiments of the disclosure, the reconstructed picture block is a reconstructed picture block of the current picture block for a first component.

The first component may be a luma component or a chroma component.

In some embodiments, S604 includes the following S604-A and S604-B.

S604-A. First feature information of the reconstructed picture block is obtained by performing feature weighting on the reconstructed picture block based on the quantization parameter.

S604-B. The enhanced picture block is determined according to the first feature information.

The specific implementation of S604-A is not limited in embodiments of the disclosure.

In a possible implementation, feature information of the reconstructed picture block is extracted based on the quantization parameter. For example, the quantization parameter and the reconstructed picture block are input into a neural network layer to extract the feature information of the reconstructed picture block. Then, the feature information is analyzed and different weights are assigned to different features. For example, a larger weight is assigned to an important feature in the feature information to enhance the influence of the feature, and a smaller weight is assigned to an unimportant feature in the feature information to weaken the influence of the feature. Then, the first feature information of the reconstructed picture block is obtained by weighting the feature information of the reconstructed picture block according to weights corresponding to respective features.

In another possible implementation, as illustrated in FIG. 6, the enhancement model in embodiments of the disclosure includes a first feature-extraction module. The first feature-extraction module is configured to extract at least one feature of the input information, i.e., the reconstructed picture block and the quantization parameter, and assign different weights to the at least one extracted feature for feature weighting.

As illustrated in FIG. 6, in embodiments of the disclosure, the enhancement model includes a first feature-extraction module. The first feature-extraction module is configured to weight extracted features. Specifically, the reconstructed picture block and the quantization parameter (optionally, after being fused in the manner of Example 1 or Example 2) are input into the first feature-extraction module. The first feature-extraction module performs feature extraction to extract at least one feature, and assigns a larger weight to an important feature among the at least one feature to enhance the influence of the feature, and assigns a smaller weight to an unimportant feature among the at least one feature to weaken the influence of the feature. Then, the first feature-extraction module performs weighting according to the weight corresponding to the at least one feature to obtain the first feature information of the reconstructed picture block. Finally, based on the first feature information of the reconstructed picture block, the enhanced picture block of the reconstructed picture block is determined.

In embodiments of the disclosure, different weights can be assigned to different features to enhance the influence of important features and weaken the influence of unimportant features, thereby further improving the effect of quality enhancement on the reconstructed picture block.

The network model of the first feature-extraction module is not limited in embodiments of the disclosure. For example, the first feature-extraction module includes multiple convolutional layers and attention mechanisms, etc.

In another possible implementation, S604-A includes the following.

S604-A1. i-th feature information of the reconstructed picture block is obtained by performing feature weighting on (i-1)-th feature information of the reconstructed picture block based on the quantization parameter, where i is a positive integer from 1 to N, and N-th feature information of the reconstructed picture block is obtained by repeating feature weighting, where when i=1, the (i-1)-th feature information is the reconstructed picture block.

S604-A2. The first feature information of the reconstructed picture block is determined according to the N-th feature information.

In this implementation, the encoding end performs N feature weighting iterations on the reconstructed picture block based on the quantization parameter to obtain the N-th feature information of the reconstructed picture block. Specifically, feature weighting is performed on the reconstructed picture block based on the quantization parameter to obtain the 1st feature information of the reconstructed picture block. Then, feature weighting is performed on the 1st feature information to obtain the 2nd feature information of the reconstructed picture block. The process is performed iteratively and feature weighting is performed on the (N-1)-th feature information based on the quantization parameter to obtain the N-th feature information of the reconstructed picture block. It should be noted that, the specific manner of feature weighting is not limited in embodiments of the disclosure. Exemplarily, the quantization parameter and the (i-1)-th feature information are input into a neural network with feature weighting function to obtain the i-th feature information of the reconstructed picture block.

In some embodiments, as illustrated in FIG. 7, the first feature-extraction module in embodiments of the disclosure includes N first feature-extraction units. If N is greater than 1, the N first feature-extraction units are connected in series, that is, the output of the previous first feature-extraction unit is the input of the next first feature-extraction unit. The reconstructed picture block is subjected to feature weighting by the N first feature-extraction units based on the quantization parameter to obtain the N-th feature information of the reconstructed picture block. As illustrated in FIG. 7, each of the N first feature-extraction units is configured to extract at least one feature, and assign a larger weight to an important feature among the at least one feature to enhance the influence of the feature, and assign a smaller weight to an unimportant feature among the at least one feature to weaken the influence of the feature. The next first feature-extraction unit further performs feature extraction and weight assignment on the feature information output by the previous first feature-extraction unit, so as to further highlight important features. After the processing by the N first feature-extraction units, important features of the reconstructed picture block can be primarily enhanced, and unimportant features in the reconstructed picture block can be slightly enhanced, thereby improving the enhancement effect on the reconstructed picture block.

In one example, if N is 1, that is, the first feature-extraction module includes one first feature-extraction unit, S604-A1 includes the following. The encoding end fuses the reconstructed picture and the quantization coefficient, and then inputs them into the first feature-extraction unit. The first feature-extraction unit performs feature extraction to extract at least one feature, and assigns different weights to features among the at least one feature according to their importance. Then, the first feature-extraction unit performs weighting on the at least one feature according to different weights to obtain the 1st feature information. Finally, the first feature information of the reconstructed picture block is determined according to the 1st feature information. For example, the 1st feature information is determined as the first feature information of the reconstructed picture block.

In another example, if N is greater than 1, that is, the first feature-extraction module includes multiple first feature-extraction units, S604-A1 includes the following. The encoding end fuses the reconstructed picture and the quantization coefficient, and then inputs them into the 1st first feature-extraction unit. The 1st first feature-extraction unit performs feature weighting, that is, extracts at least one feature and determines a weight for each of the at least one feature, and then weights the at least one feature according to the weight to obtain feature information output by the 1st first feature-extraction unit. For the convenience of description, the feature information is denoted as the 1st feature information M₁. Then, the 1st feature information Mᵢ is input into the 2nd first feature-extraction unit for feature weighting to obtain the 2nd feature information M₂, and so on. For the i-th first feature-extraction unit among the N first feature-extraction units, the (i-1)-th feature information Mᵢ₋₁ output by the (i-1)-th first feature-extraction unit is input into the i-th first feature-extraction unit for feature weighting to obtain the i-th feature information Mᵢ. Finally, the N-th feature information M_{N} output by the N-th first feature-extraction unit is obtained. The first feature information of the reconstructed picture block is determined according to the N-th feature information M_{N}. For example, the N-th feature information is determined as the first feature information of the reconstructed picture block.

The specific network structure of the first feature-extraction unit is not limited in embodiments of the disclosure. For example, the first feature-extraction unit includes at least one convolutional layer and attention mechanism.

In some embodiments, in S604-A1, the i-th feature information of the reconstructed picture block is obtained by performing feature weighting on the (i-1)-th feature information of the reconstructed picture block based on the quantization parameter as follows.

S604-A11. M feature information of different scales is extracted from the (i-1)-th feature information, where M is a positive integer greater than 1.

S604-A12. i-th weighted feature information is obtained by weighting the M feature information of different scales.

S604-A13. The i-th feature information is determined according to the i-th weighted feature information.

Specifically, the encoding end performs multi-scale feature extraction on the (i-1)-th feature information to obtain M feature information of different scales of the (i-1)-th feature information, and then performs weighting on the M feature information of different scales to obtain the i-th weighted feature information. For example, according to the importance of the feature, a larger weight is assigned to an important feature, and a smaller weight is assigned to an unimportant feature. Then, the M feature information of different scales is weighted according to weights of respective features to obtain the i-th weighted feature information of the reconstructed picture block. Finally, the i-th feature information is determined according to the i-th weighted feature information. For example, the i-th weighted feature information is determined as the i-th feature information.

In one example, if the encoding end extracts the i-th feature information of the reconstructed picture block through the first feature-extraction unit, as illustrated in FIG. 8, the first feature-extraction unit includes a multi-scale extraction layer, where the multi-scale extraction layer is used to extract features at multiple scales.

Exemplarily, as illustrated in FIG. 8, taking the i-th first feature-extraction unit among the N first feature-extraction units as an example, the input of the i-th first feature-extraction unit is the output of the (i-1)-th first feature-extraction unit. The (i-1)-th feature information Mᵢ₋₁ output by the (i-1)-th first feature-extraction unit is input into the multi-scale extraction layer in the i-th first feature-extraction unit. The multi-scale extraction layer is used to extract features of multiple scales, for example, to extract M feature information at different scales. Next, different weights are assigned to different features in the M feature information (D₁, D₂, . . . , D_{M}) at different scales extracted by the multi-scale extraction layer, and a weighting operation is performed to obtain the i-th weighted feature information G₁. Finally, the i-th feature information Mᵢ is determined according to the i-th weighted feature information G₁. For example, the i-th weighted feature information G₁ is determined as the i-th feature information Mᵢ output by the i-th first feature-extraction unit.

As can be seen, in embodiments of the disclosure, the first feature-extraction unit performs multi-scale feature extraction to better explore the relationship between the input reconstructed picture block and the real picture block, so as to further improve the enhancement effect on the reconstructed picture block.

In some examples, the multi-scale extraction layer includes a convolution layer and a downsampling layer. For example, the convolution layer is used to output feature information, and the downsampling layer is used to downsample the feature information output by the convolution layer to obtain M feature information at different scales.

In another example, as illustrated in FIG. 9, the multi-scale extraction layer includes M first feature-extraction layers of different scales, and each first feature-extraction layer can extract feature information at a corresponding scale.

Based on FIG. 9, S604-A11 includes the following. M feature information D₁, D₂. . . , D_{M} of different scales is extracted from the (i-1)-th feature information through the M first feature-extraction layers of different scales.

The specific network structure of the first feature-extraction layer is not limited in embodiments of the disclosure.

In some embodiments, the first feature-extraction layer includes a convolution layer, and different first feature-extraction layers include convolution layers with convolution kernels of different sizes.

For example, assume that M=2, that is, the first feature-extraction unit includes two first feature-extraction layers, and assume that the size of the convolution kernel of one first feature-extraction layer is 3×3, and the size of the convolution kernel of the other first feature-extraction layer is 5×5, the 3×3 convolution kernel and the 5×5 convolution kernel are used to perform feature extraction on the input (i-1)-th feature information Mᵢ₋₁∈ [symbol] ^{64×128×128} to obtain feature information D₁∈□^{64×128×128} and feature information D₂∈□^{64×128×128}.

In some embodiments, among the M first feature-extraction layers of different scales, at least one first feature-extraction layer includes an activation function.

According to the above, the (i-1)-th feature information is input into the multi-scale extraction layer to obtain M feature information D₁, D₂, . . . , D_{M} of different scales. Then, S604-A12 is implemented to weight the M feature information D₁, D₂, . . . , D_{M} of different scales to obtain the i-th weighted feature information G₁.

The encoding end can fuse the M feature information of different scales and perform weighting to obtain the i-th weighted feature information.

The specific manner of fusing the M feature information of different scales is not limited in embodiments of the disclosure. For example, the M feature information of different scales may be added or multiplied.

In some embodiments, S604-A12 includes the following.

S604-A12-1. First concatenated feature information is obtained by concatenating the M feature information of different scales, and the i-th weighted feature information is obtained by weighting the first concatenated feature information.

Specifically, the M feature information D₁, D₂, . . . , D_{M} of different scales are concatenated on channels to obtain the first concatenated feature information X, and X is weighted to obtain the i-th weighted feature information G₁. For example, a larger weight is assigned to an important feature in X, and a smaller weight is assigned to an unimportant feature in X. Then, features in X are weighted according to weights of respective features to obtain the i-th weighted feature information G₁.

The specific implementation of weighting the M feature information of different scales to obtain the i-th weighted feature information in S604-A12 is not limited in embodiments of the disclosure.

In a possible implementation, the i-th weighted feature information is obtained by weighting the concatenated feature information in S604-A12-1 as follows.

S604-A12-11. Weighted feature information with a first number of channels is obtained by weighting the first concatenated feature information through a weighting layer.

S604-A12-12. The i-th weighted feature information is obtained according to the weighted feature information with the first number of channels.

For example, as illustrated in FIG. 8, the first feature-extraction unit further includes a weighting layer, and the weighting layer is used to perform weighting on features at multiple scales. In this way, the encoding end inputs the (i-1)-th feature information Mᵢ₋₁ output by the (i-1)-th first feature-extraction unit into the multi-scale extraction layer, for example, into M first feature-extraction layers of different scales. The M first feature-extraction layers of different scales output M feature information D₁, D₂, . . . , D_{M}. The M feature information D₁, D₂, . . . , D_{M} are concatenated and then input into the weighting layer. The weighting layer performs feature weighting on the concatenated feature information to obtain the weighted feature information \hat{X} with the first number of channels. Then, the i-th weighted feature information is obtained according to the weighted feature information \hat{X} with the first number of channels.

In some embodiments, since the M feature information of different scales is concatenated and then input into the weighting layer, the number of channels of the feature information output by the weighting layer may be different from the number of channels of the (i-1)-th feature information. Therefore, as illustrated in FIG. 10, in embodiments of the disclosure, the first feature-extraction unit of further includes a second feature-extraction layer. The feature-extraction layer is used to change the number of channels. In this case, the encoding end may input the weighted feature information \hat{X} with the first number of channels into the second feature-extraction layer to change the number of channels and output the i-th weighted feature information G₁.

In some embodiments, the number of channels of feature information output by each of the N first feature-extraction units may be the same. For example, the number of channels of the i-th weighted feature information is the same as the number of channels of the (i-1)-th feature information.

The specific network structure of the weighting layer is not limited in embodiments of the disclosure. Exemplarily, the weighting layer includes a neuron attention mechanism.

The network structure of the second feature-extraction layer is not limited in embodiments of the disclosure. For example, the second feature-extraction layer includes a 1×1 convolution layer.

After the i-th weighted feature information is obtained in above steps, S604-A13 is implemented to determine the i-th feature information according to the i-th weighted feature information.

In one example, the i-th weighted feature information is determined as the i-th feature information.

In another example, a sum of the i-th weighted feature information and the (i-1)-th feature information is determined as the i-th feature information.

The following introduces the network structure of the i-th first feature-extraction unit in embodiments of the disclosure by examples.

As illustrated in FIG. 11, in embodiments of the disclosure, the i-th first feature-extraction unit includes a multi-scale extraction layer, a weighting layer, and a second feature-extraction layer. The multi-scale extraction layer includes two first feature-extraction layers. The network structures of the two first feature-extraction layers are basically the same. The two first feature-extraction layers each include a convolution layer and an activation function. However, the sizes of convolution kernels included in the two first feature-extraction layers are different. One convolution kernel has a size of 3×3, and the other convolution kernel has a size of 5×5. Exemplarily, the activation function included in the two first feature-extraction layers is ReLu. It should be noted that, the activation function can also be activation functions in other forms. The second feature-extraction layer includes a convolution layer with a convolution kernel of size 1×1 to reduce the number of feature channels.

The following introduces the network structure of the i-th first feature-extraction unit in embodiments of the disclosure by examples.

As illustrated in FIG. 11, in embodiments of the disclosure, the i-th first feature-extraction unit includes a multi-scale extraction layer, a weighting layer, and a second feature-extraction layer. The multi-scale extraction layer includes two first feature-extraction layers. The network structures of the two first feature-extraction layers are basically the same. The two first feature-extraction layers each include a convolution layer and an activation function. However, the sizes of convolution kernels included in the two first feature-extraction layers are different. One convolution kernel has a size of 3×3, and the other convolution kernel has a size of 5×5. Exemplarily, the activation function included in the two first feature-extraction layers is ReLu. It should be noted that, the activation function can also be activation functions in other forms. The second feature-extraction layer includes a convolution layer with a convolution kernel of size 1×1 to reduce the number of feature channels.

Specifically, as illustrated in FIG. 11, the (i-1)-th feature information Mᵢ₋₁∈ [symbol] ^{64×128×128} output by the (i-1)-th first feature-extraction unit is respectively input into the two first feature-extraction layers. The two first feature-extraction layers perform multi-scale feature extraction and output feature information D₁∈□^{64×128×128} and feature information D₂∈□^{64×128×128}. Then, the feature information D₁∈□^{64×128×128} and feature information D₂∈ [symbol] ^{64×128×128} are concatenated to obtain the first concatenated feature information X∈ [symbol] ^{128×128×128}.

Exemplarily, the feature information C₁, C₂, and X are determined by formula (1).

Next, the first concatenated feature information X∈□^{128×128×128} is input into the weighting layer for feature weighting. Specifically, a larger weight is assigned to an important feature to enhance the influence of the feature, and a smaller weight is assigned to an unimportant feature to weaken the influence of the feature. The weighting layer outputs weighted feature information \hat{X}∈□^{128×128×128} with a first number of channels. The feature information \hat{X}∈□^{128×128×128} is then input into the second feature-extraction layer to reduce the number of feature channels. Specifically, a 1×1 convolution operation is performed on X to obtain the i-th weighted feature information D₃∈ [symbol] ^{64×128×128}, so as to reduce the number of feature channels. D₃ is added to the input Mᵢ₋₁ to obtain the i-th feature information M₁∈□^{64×128×128} output by the i-th first feature-extraction unit.

Exemplarily, the feature information D₃ and Mᵢ₋₁ are determined by formula (2).

The specific network structure of the weighting layer is not limited in embodiments of the disclosure.

In some embodiments, the weighting layer includes a neuron attention mechanism.

Exemplarily, the network structure of the neuron attention mechanism is as illustrated in FIG. 12, which includes a depth wise convolution, a point wise convolution, and activation functions. Specifically, the concatenated feature X is convolved on different channels through the depth wise convolution operation, and then subjected to the ReLU activation function and then the point wise convolution operation, so that information of different feature maps is fused. Then, a weight feature map V∈□^{128×128×128} is obtained through a Sigmoid activation function, and V is multiplied by X element by element to obtain the weighted feature information \hat{X}∈ [symbol] ^{128×128×128} with the first number of channels.

Exemplarily, the weighted feature information \hat{X} with the first number of channels may be determined by formula (3).

After the weighted feature information \hat{X} having the first number of channels is determined according to formula (3), \hat{X} is substituted into formula (2) to determine the i-th feature information Mᵢ.

In the above, the extraction of the i-th feature information by the i-th first feature-extraction unit among the N first feature-extraction units is taken as an example. For other first feature-extraction units among the N first feature-extraction units, reference can be made to the extraction of the i-th feature information by the i-th first feature-extraction unit. As such, finally, the N-th feature information can be extracted by the N-th first feature-extraction unit.

Next, S604-A2 is implemented to determine the first feature information of the reconstructed picture block according to the N-th feature information output by the N-th first feature-extraction unit.

The implementation manner of S604-A2 includes but is not limited to the following.

Manner 1. The N-th feature information is determined as the first feature information of the reconstructed picture block.

Manner 2. S604-A2 includes S604-A2-1: the first feature information of the reconstructed picture block is obtained according to the N-th feature information and at least one of first N-1 feature information prior to the N-th feature information.

As can be seen, the encoding end performs N iterative feature weighting on the reconstructed picture block based on the quantization parameter. For example, the i-th feature information of the reconstructed picture block is obtained by performing feature weighting on the (i-1)-th feature information of the reconstructed picture block based on the quantization parameter, where i is a positive integer from 1 to N, and the N-th feature information of the reconstructed picture block is obtained by repeating feature weighting. As such, the first feature information of the reconstructed picture block can be obtained based on the N-th feature information and at least one of the first N-1 feature information prior to the N-th feature information. For example, the at least one of the first N-1 feature information is concatenated with the N-th feature information, and then feature extraction is performed to obtain the first feature information of the reconstructed picture block.

In some embodiments, as illustrated in FIG. 13, the first feature-extraction module includes, in addition to N first feature-extraction units, a second feature-extraction unit. The second feature-extraction unit is configured to perform feature extraction on feature information output by at least one of the first N-1 first feature-extraction units and the N-th feature information output by the N-th first feature-extraction unit, so as to obtain deeper feature information. Specifically, feature information output by at least one of the first N-1 first feature-extraction modules among the N first feature-extraction modules and the N-th feature information M_{N} output by the N-th first feature-extraction module are inputted into the second feature-extraction unit. For example, feature information output by at least one of the first N-1 first feature-extraction modules is concatenated with the N-th feature information M_{N} and then input into the second feature-extraction unit. The second feature-extraction unit performs deeper feature extraction to obtain the first feature information F1 of the reconstructed picture block.

In some embodiments, S604-A2-1 also includes the following. Feature information output by at least one first feature-extraction module among the first N-1 first feature-extraction modules, the N-th feature information, the reconstructed picture block, and the quantization parameter are concatenated and then input into the second feature-extraction unit to obtain the first feature information of the reconstructed picture block.

In this embodiment, in order to further generate the first feature information satisfying requirements, the reconstructed picture block and the quantization parameter, together with the feature information output by the at least one first feature-extraction module and the N-th feature information, are input into the second feature-extraction unit for feature extraction, so that the feature extraction is supervised by the reconstructed picture block and the quantization parameter, and the first feature information output better meets the requirements.

In some embodiments, in order to improve the accuracy of determining the first feature information of the reconstructed picture block, in embodiments of the disclosure, shallow feature information (i.e., second feature information) of the reconstructed picture block is first extracted, and then the first feature information of the reconstructed picture block is determined based on the second feature information.

Based on this, S604-A includes the following. Second feature information of the reconstructed picture block is extracted based on the quantization parameter. The first feature information of the reconstructed picture block is obtained by performing feature weighting on the second feature information.

Specifically, shallow feature extraction is performed on the reconstructed picture block based on the quantization parameter to obtain the second feature information of the reconstructed picture block. For example, concatenated information is obtained by concatenating the reconstructed picture block and the quantization parameter, and the second feature information of the reconstructed picture block is obtained by performing shallow feature extraction on the concatenated information. Then, the first feature information of the reconstructed picture block is determined based on the second feature information. For example, deep feature extraction is performed based on the second feature information to obtain the first feature information of the reconstructed picture block.

The specific manner of performing feature extraction on the concatenated information to obtain the second feature information is not limited in embodiments of the disclosure.

In a possible implementation, the second feature information is obtained by performing feature extraction on the concatenated information through a second feature-extraction module.

For example, as illustrated in FIG. 14, in embodiments of the disclosure, the enhancement model includes, in addition to the first feature-extraction module, a second feature-extraction module. The second feature-extraction module is configured to extract shallow feature information of the reconstructed picture block, and input the extracted shallow feature information into the first feature-extraction module for deep feature extraction. Specifically, as illustrated in FIG. 14, the encoding end first concatenates the reconstructed picture and the quantization parameter to obtain concatenated information, and then inputs the concatenated information into the second feature-extraction module for shallow feature extraction, to obtain the second feature information C2 of the reconstructed picture block. Then, the shallow second feature information C2 is input into the first feature-extraction module to obtain the first feature information F1 of the reconstructed picture block.

In this case, in some embodiments, S604-A2-1 includes the following. Second concatenated feature information is obtained by concatenating the at least one of the first N-1 feature information, the N-th feature information, and the second feature information. The first feature information of the reconstructed picture block is obtained by performing feature extraction on the second concatenated feature information.

Exemplarily, as illustrated in FIG. 15, the feature information output by at least one of the first N-1 first feature-extraction modules, the N-th feature information M_{N}, and the second feature information C2 are concatenated and then input into the second feature-extraction unit to obtain the first feature information F1 of the reconstructed picture block.

The specific network structure of the second feature-extraction module is not limited in embodiments of the disclosure.

In one example, the second feature-extraction module includes at least one convolutional layer.

Exemplarily, if the second feature-extraction module includes two convolutional layers, the encoding end obtains the second feature information of the reconstructed picture block through the two convolutional layers.

In an example, the second feature information C2 can be determined by formula (4).

According to the above, after the second feature information of the reconstructed picture block is determined, the second feature information is input into the first feature-extraction module for deep feature extraction to obtain the first feature information of the reconstructed picture block. The enhanced picture block of the reconstructed picture block is determined according to the first feature information of the reconstructed picture block.

The specific manner of determining the enhanced picture block of the reconstructed picture block according to the first feature information of the reconstructed picture block in S604-B is not limited in embodiments of the disclosure.

According to the above, after the second feature information of the reconstructed picture block is determined, the second feature information is subjected to feature weighting to obtain the first feature information of the reconstructed picture block. The enhanced picture block of the reconstructed picture block is determined according to the first feature information of the reconstructed picture block.

The specific manner of determining the enhanced picture block of the reconstructed picture block according to the first feature information of the reconstructed picture block in S604-B is not limited in embodiments of the disclosure.

In some embodiments, if the first feature information of the reconstructed picture block is consistent with the reconstructed picture block in terms of the size, the first feature information may be determined as the enhanced picture block.

In some embodiments, S604-B includes the following. The enhanced picture block is obtained by performing nonlinear mapping on the first feature information of the reconstructed picture block.

The specific manner of performing nonlinear mapping on the first feature information of the reconstructed picture block to obtain the enhanced picture block in S604-B is not limited in embodiments of the disclosure.

For example, the first feature information of the reconstructed picture block is processed in a nonlinear mapping manner, so that the size of the processed first feature information of the reconstructed picture block is consistent with the size of the reconstructed picture block, and then the processed first feature information of the reconstructed picture block is used as the enhanced picture block.

In some embodiments, as illustrated in FIG. 17, in embodiments of the disclosure, the enhancement model further includes a reconstruction module. The reconstruction module is configured to perform further nonlinear mapping on the first feature information extracted by the first feature-extraction module.

Based on FIG. 17, S604-B includes the following. The enhanced picture block is obtained by performing nonlinear mapping on the first feature information of the reconstructed picture block through a reconstruction module.

The network model of the reconstruction module is not limited in embodiments of the disclosure.

In some embodiments, the reconstruction module includes at least one convolutional layer.

Exemplarily, as illustrated in FIG. 18, the reconstruction module includes two convolutional layers. The encoding end inputs the first feature information F1 of the reconstructed picture block output by the first feature-extraction module into the reconstruction module. After convolution operations at the two convolutional layers, the enhanced picture block O1 of the reconstructed picture block is obtained.

In embodiments of the disclosure, the encoding end performs quality enhancement on the reconstructed picture block based on the quantization parameter through the above steps to obtain the enhanced picture block of the reconstructed picture block.

In some embodiments, before performing quality enhancement on the reconstructed picture block, the encoding end needs to determine whether to perform quality enhancement on the reconstructed picture block. In other words, the encoding end performs quality enhancement on the reconstructed picture block when determining that quality enhancement on the reconstructed picture block provides better effect than no quality enhancement.

The manner in which the encoding end determines whether to perform quality enhancement on the reconstructed picture block includes but is not limited to the following.

Manner 1. The profile contains a first flag, where the first flag indicates whether to perform quality enhancement on the reconstructed picture block of the current picture block. In this way, the encoding end can determine whether to perform quality enhancement on the reconstructed picture block of the current picture block according to the first flag. For example, if the value of the first flag is a first value, for example, 1, the encoding end determines to perform quality enhancement on the reconstructed picture block of the current picture block, and then perform the method in above embodiments. If the value of the first flag is a second value, for example, 0, the encoding end determines not to perform quality enhancement on the reconstructed picture block of the current picture block, but to filter the reconstructed picture block using an existing in-loop filtering method.

Manner 2. The encoding end determines on its own whether to perform quality enhancement on the reconstructed picture block.

Specifically, the encoding end first performs quality enhancement on the reconstructed picture block based on the quantization parameter to obtain a test enhanced picture block. Then, the encoding end determines the picture quality corresponding to the test enhanced picture block and the picture quality corresponding to the unenhanced reconstructed picture block. If the picture quality of the test enhanced picture block is greater than the picture quality of the reconstructed picture block, it means that the enhancement method in embodiments of the disclosure can achieve a significant enhancement effect. In this case, the encoding end determines the determined test enhanced picture block as the enhanced picture block of the reconstructed picture block for direct output for display, and/or saves the determined test enhanced picture block in the decoded picture buffer as an intra-frame reference for subsequent picture blocks.

If the picture quality of the test enhanced picture block is less than or equal to the picture quality of the reconstructed picture block, it means that the enhancement model cannot achieve a significant enhancement effect. In this case, the reconstructed picture block is directly output for display after being in-loop filtered, and/or the in-loop filtered reconstructed picture block is saved in the decoded picture buffer as an intra-frame reference for subsequent picture blocks.

In some embodiments, the encoding end signals the first flag in the bitstream, where the first flag indicates whether to perform quality enhancement on the reconstructed picture block of the current picture block. In this way, the decoding end can determine whether to perform quality enhancement on the reconstructed picture block of the current picture block according to the first flag, so as to ensure the consistency at the encoding end.

Specifically, if the encoding end determines to perform quality enhancement on the reconstructed picture block of the current picture block, the value of the first flag is set to a first value, for example, 1. If the encoding end determines not to perform quality enhancement on the reconstructed picture block of the current picture block, the value of the first flag is set to a second value, for example, 0. In this way, the decoding end first decodes the bitstream to obtain the first flag, and determines whether to perform quality enhancement on the reconstructed picture block of the current picture block according to the first flag.

Optionally, the first flag may be a sequence-level flag.

Optionally, the first flag may be a frame-level flag.

Optionally, the first flag may be a slice-level flag.

Optionally, the first flag may be a block-level flag, such as a CTU-level flag.

In some embodiments, the reconstructed picture block is a reconstructed picture block subjected to in-loop filtering. For example, the encoding end determines a prediction block of the current picture block and a residual block of the current picture block, and adds the residual block to the prediction block to obtain the reconstructed picture block. The reconstructed picture block is then filtered by an in-loop filter, and the filtered reconstructed picture block is input into the enhancement model for quality enhancement.

In some embodiments, in embodiments of the disclosure, the reconstructed picture block may be subjected to quality enhancement by the enhancement model, and then in-loop filtering.

In some embodiments, in embodiments of the disclosure, the reconstructed picture block is subjected to quality enhancement by the enhancement model, but no further in-loop filtering.

In some embodiments, in embodiments of the disclosure, after the enhancement model performs quality enhancement on the reconstructed picture block, the enhanced picture block may be displayed and stored in the decoded picture buffer as a reference for other picture blocks.

Optionally, the encoding end may display the enhanced picture block and store the unenhanced reconstructed picture block in the decoded picture buffer as a reference for other picture blocks.

Optionally, the encoding end may display the reconstructed picture block and store the enhanced picture block in the decoded picture buffer as a reference for other picture blocks.

It should be noted that before being used for quality enhancement, the enhancement model needs to be trained first.

Further, in order to illustrate the beneficial effect of the method for picture processing provided in embodiments of the disclosure, the solution in embodiments of the disclosure is tested, for example, in a VVC test software VTM8.2. The test sequence used includes sequences of Class A, Class B, Class C, and Class E given in a general test condition. Results in Table 1 are obtained with the QP set to 32, 37, 42, 47 and encoding in the AI mode.

TABLE 1
Test results of BD-rate of the proposed method in VTM8.2

| Class | Sequence | Y | Cb | Cr |
|---|---|---|---|---|
| Class A | Tango2 | −0.04% | −0.99% | 0.15% |
| | FoodMarket4 | 0.78% | 0.69% | 1.39% |
| | Campfire | −0.63% | 0.12% | 0.02% |
| | CatRobot1 | −1.02% | −0.19% | 0.39% |
| | DaylightRoad2 | −1.48% | −1.26% | 1.17% |
| | ParkRunning3 | −2.16% | −0.33% | 0.07% |
| Class B | MarketPlace | −0.97% | −1.34% | 0.60% |
| | RitualDance | −1.97% | 0.84% | 0.94% |
| | Cactus | −1.47% | 1.45% | −0.52% |
| | BasketballDrive | 0.30% | −0.26% | −0.18% |
| | BQTerrace | −1.17% | 1.32% | −1.47% |
| Class C | BasketballDrill | −2.51% | 0.54% | −1.87% |
| | BQMall | −0.59% | −1.10% | −1.89% |
| | PartyScene | −1.61% | −3.80% | −1.69% |
| | RaceHorses | −1.86% | −1.21% | −1.39% |
| Class E | FourPeople | −2.16% | −0.54% | 0.76% |
| | Johnny | −1.85% | −0.98% | 2.68% |
| | KristenAndSara | −1.87% | 0.90% | −1.56% |

| | | | |
|---|---|---|---|
| Average | −1.24% | −0.34% | −0.16% |

Explanation of the parameters in Table 1 above is as follows.

Class refers to the class of the video, Sequence refers to the specific test sequence, and Y, Cb, and Cr refer to the performance of three components of the video in terms of luma and chroma. The values in Table 1 are BD-rates. The BD-rate is used to measure the performance of the algorithm, and indicates the change in bit rate and PSNR of the new coding algorithm compared with the original algorithm. Most BD-rates are negative, which indicates that the performance is improved. The larger the absolute value of the BD-rate, the greater the performance improvement.

According to the method for picture processing provided in embodiments of the disclosure, the encoding end determines the quantization parameter of the current picture block, and encodes the current picture block based on the quantization parameter to obtain the quantization coefficient of the current picture block, obtains the residual block of the current picture block by performing inverse quantization on the quantization coefficient based on the quantization parameter of the current picture block, and obtains the enhanced picture block by performing quality enhancement on the reconstructed picture block based on the quantization parameter according to the residual block. Different picture blocks may correspond to different quantization coefficients. Therefore, in the disclosure, to improve the accuracy of the enhancement of the picture block, quality enhancement is performed on the reconstructed picture block based on the quantization coefficient, thereby improving the enhancement effect. In addition, in the disclosure, picture quality enhancement is performed in units of picture blocks, so that when the enhanced picture block is used as a reference block for other picture blocks in intra prediction, a more accurate reference can be provided, thereby improving the accuracy of intra prediction.

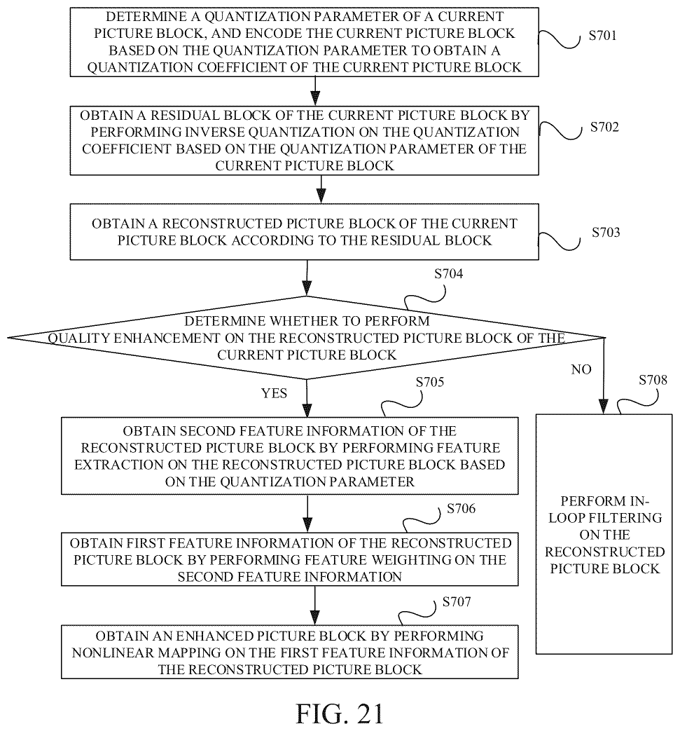

FIG. 21 is a schematic flowchart of a method for picture processing provided in embodiments of the disclosure. FIG. 21 can be understood as a more specific method with respect to the method for picture processing illustrated in FIG. 20. As illustrated in FIG. 21, the method for picture processing in embodiments of the disclosure includes the following.

S701. A quantization parameter of a current picture block is determined, and the current picture block is encoded based on the quantization parameter to obtain a quantization coefficient of the current picture block.

S702. A residual block of the current picture block is obtained by performing inverse quantization on the quantization coefficient based on the quantization parameter of the current picture block.

S703. A reconstructed picture block of the current picture block is obtained according to the residual block.

The specific implementation of S701 and S703 may refer to the description of S601 to S603, which will not be repeated herein.

S704. Whether to perform quality enhancement on the reconstructed picture block of the current picture block is determined.

Manner 1. A first flag is obtained, and whether quality enhancement is allowed for the reconstructed picture block of the current picture block is determined according to the first flag.

Manner 2. Quality enhancement is performed on the reconstructed picture block based on the quantization parameter to obtain a test enhanced picture block, determines a first picture quality of the test enhanced picture block and a second picture quality of the reconstructed picture block, and determines whether to perform quality enhancement on the reconstructed picture block of the current picture block based on the first picture quality and the second picture quality.

If it is determined to perform quality enhancement on the reconstructed picture block of the current picture block, the following S705 is implemented.

If it is determined not to perform quality enhancement on the reconstructed picture block of the current picture block, the following S708 is implemented.

S705. Second feature information of the reconstructed picture block is obtained by performing feature extraction on the reconstructed picture block based on the quantization parameter.

S706. First feature information of the reconstructed picture block is obtained by performing feature weighting on the second feature information.

S707. An enhanced picture block is obtained by performing nonlinear mapping on the first feature information of the reconstructed picture block.

In some embodiments, the enhanced picture block is obtained by performing quality enhancement on the reconstructed picture block using an enhancement model.

Exemplarily, as illustrated in FIG. 18, in embodiments of the disclosure, the enhancement model includes a second feature-extraction module, a first feature-extraction module, and a reconstruction module. The second feature-extraction module is configured to extract shallow features (i.e., the second feature information of the reconstructed picture block). The first feature-extraction module is configured to extract deep features (i.e., the first feature information of the reconstructed picture block). The reconstruction module is configured to perform nonlinear mapping on the deep features to obtain the final enhanced picture block.

Exemplarily, the second feature-extraction module illustrated in FIG. 18 includes two convolutional layers. However, the structure of the second feature-extraction module provided in embodiments of the disclosure includes but is not limited to that illustrated in FIG. 18.

Exemplarily, as illustrated in FIG. 18, the first feature-extraction module includes N first feature-extraction layers and one second feature-extraction layer. The N first feature-extraction layers are connected in series. Both the outputs of the N first feature-extraction layers and the output of the second feature-extraction module are input into the second feature-extraction layer. However, the network structure of the first feature-extraction module provided in embodiments of the disclosure includes but is not limited to that illustrated in FIG. 18.

Exemplarily, as illustrated in FIG. 18, the reconstruction module includes two convolutional layers. However, the network structure of the reconstruction module provided in embodiments of the disclosure includes but is not limited to that illustrated in FIG. 18.

In some embodiments, the first feature-extraction layer in embodiments of the disclosure includes a multi-scale extraction layer and a neuron attention mechanism. The multi-scale extraction layer is used to perform multi-scale feature extraction. The neuron attention mechanism is used for feature weighting. In this case, the first feature-extraction layer in embodiments of the disclosure may also be referred to as a multi-scale and neuron attention (MSNA) unit.

In some embodiments, the enhancement model in embodiments of the disclosure is also referred to as a neuron attention-based CNN (NACNN).

Specifically, as illustrated in FIG. 18, the encoding end performs normalization and then concatenation on the reconstructed picture block and the quantization parameter, and inputs the concatenation result into the enhancement model. The first convolution layer in the second feature-extraction module performs a convolution operation on the reconstructed picture block and the quantization parameter to obtain feature information C1, and then inputs the feature information C1 into the second convolution layer for convolution to obtain second feature information C2. The encoding end inputs the second feature information C2 into the first feature-extraction module, and the 1st first feature-extraction unit in the first feature-extraction module performs multi-scale feature extraction and feature weighting on C2 to obtain the 1st feature information M1. Next, the 1st feature information M1 is input into the 2nd first feature-extraction unit for multi-scale feature extraction and feature weighting to obtain the 2nd feature information M2. By analogy, the N-th feature information MN output by the N-th first feature-extraction unit is obtained. At the encoding end, the N feature information M1, M2, . . . , MN extracted by respective layers in the first feature-extraction module and the second feature information C2 output by the second feature module are concatenated and then input into the second feature-extraction layer in the first feature-extraction module to change the number of channels and output the first feature information F1 of the reconstructed picture block. Then, the encoding end inputs the first feature information F1 into the reconstruction module for reconstruction. Specifically, the first convolution layer in the reconstruction module performs a convolution operation to obtain feature information C3, and the second convolution layer in the reconstruction module performs a convolution operation on the feature information C3 to obtain feature information C4. Finally, the enhanced picture block O1 of the reconstructed picture block is obtained according to the feature information C4. For example, the feature information C4 is output as the enhanced picture block O1 of the reconstructed picture block.

It should be noted that the specific implementation of S705 to S707 may refer to the specific description of S604, which will not be repeated herein.

S708. In-loop filtering is performed on the reconstructed picture block.

In some embodiments, if the encoding end determines not to perform quality enhancement on the reconstructed picture block of the current picture block using the enhancement model, S708 is implemented to perform in-loop filtering on the reconstructed picture block.

According to the method for picture processing provided in embodiments of the disclosure, before performing quality enhancement on the reconstructed picture block, the encoding end first determines whether to perform quality enhancement on the reconstructed picture block, thereby improving the reliability of picture processing. According to the method for picture processing provided in embodiments of the disclosure, before performing quality enhancement on the reconstructed picture block using the enhancement model, the encoding end first determines whether to perform quality enhancement on the reconstructed picture block using the enhancement model, thereby improving the reliability of picture processing.

It should be understood that, FIGS. 4 to 21 are merely examples of the disclosure and should not be construed as limitations to the disclosure.

Preferable implementations of the disclosure have been described in detail above with reference to the accompanying drawings. However, the disclosure is not limited to the details described in the foregoing implementations. Within the scope of the technical concept of the disclosure, various simple modifications can be made to the technical solutions of the disclosure, and these simple modifications all fall within the protection scope of the disclosure. For example, various technical features described in the foregoing implementations may be combined in any suitable manner without contradiction, and in order to avoid unnecessary redundancy, various possible combinations are not further described in the disclosure. For another example, various implementations of the disclosure may also be combined in any manner, and as long as the combinations do not depart from the idea of the disclosure, they should also be considered as contents disclosed in the disclosure.

It should also be understood that, in various method embodiments of the disclosure, the magnitude of a sequence number of each of the foregoing processes does not mean an execution order, and an execution order of each process should be determined according to a function and an internal logic of the process, which shall not constitute any limitation on an implementation process of embodiments of the disclosure. In addition, the term “and/or” herein only describes an association between associated objects, which means that there can be three relationships. Specifically, A and/or B can mean A alone, both A and B exist, and B alone. Besides, the character “/” herein generally indicates that the associated objects are in an “or” relationship.

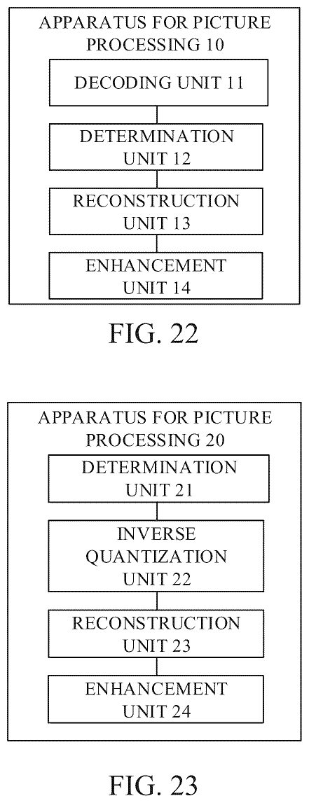

The method embodiments of the disclosure are described in detail above with reference to FIGS. 4 to 21, and the apparatus embodiments of the disclosure are described in detail below with reference to FIGS. 22 to 24.

FIG. 22 is a schematic block diagram of an apparatus for picture processing provided in embodiments of the disclosure.

As illustrated in FIG. 22, the apparatus for picture processing 10 includes a decoding unit 11, a determination unit 12, a reconstruction unit 13, and an enhancement unit 14. The decoding unit 11 is configured to decode a bitstream to obtain a quantization coefficient of a current picture block. The determination unit 12 is configured to determine a quantization parameter corresponding to the current picture block, and obtain a transform coefficient of the current picture block by performing inverse quantization on the quantization coefficient based on the quantization parameter. The reconstruction unit 13 is configured to determine a reconstructed picture block of the current picture block according to the transform coefficient. The enhancement unit 14 is configured to obtain an enhanced picture block by inputting the reconstructed picture block and the quantization parameter into an enhancement model for picture enhancement.

In some embodiments, the enhancement unit 14 is specifically configured to obtain first feature information of the reconstructed picture block by performing feature weighting on the reconstructed picture block based on the quantization parameter, and determine the enhanced picture block according to the first feature information.

In some embodiments, the enhancement unit 14 is specifically configured to obtain i-th feature information of the reconstructed picture block by performing feature weighting on (i-1)-th feature information of the reconstructed picture block based on the quantization parameter, where i is a positive integer from 1 to N, and obtain N-th feature information of the reconstructed picture block by repeating feature weighting, where when i=1, the (i-1)-th feature information is the reconstructed picture block, and determine the first feature information of the reconstructed picture block according to the N-th feature information.

In some embodiments, the enhancement unit 14 is specifically configured to extract M feature information of different scales from the (i-1)-th feature information, where M is a positive integer greater than 1, obtain i-th weighted feature information by weighting the M feature information of different scales, and determine the i-th feature information according to the i-th weighted feature information.

In some embodiments, the enhancement unit 14 is specifically configured to extract the M feature information of different scales from the (i-1)-th feature information through M first feature-extraction layers of different scales.

In some embodiments, the first feature-extraction layer includes a convolution layer, and different first feature-extraction layers include convolution layers with convolution kernels of different sizes.

In some embodiments, among the M first feature-extraction layers of different scales, at least one first feature-extraction layer includes an activation function.

In some embodiments, the enhancement unit 14 is specifically configured to obtain first concatenated feature information by concatenating the M feature information of different scales, and obtain the i-th weighted feature information by weighting the first concatenated feature information.

In some embodiments, the enhancement unit 14 is specifically configured to obtain weighted feature information with a first number of channels by weighting the first concatenated feature information through a weighting layer, and obtain the i-th weighted feature information according to the weighted feature information with the first number of channels.

In some embodiments, a number of channels of the i-th weighted feature information is the same as a number of channels of the (i-1)-th feature information.

Optionally, the weighting layer includes a neuron attention mechanism.

In some embodiments, the enhancement unit 14 is specifically configured to determine a sum of the i-th weighted feature information and the (i-1)-th feature information as the i-th feature information.

In some embodiments, the enhancement unit 14 is specifically configured to determine the i-th weighted feature information as the i-th feature information.

In some embodiments, the enhancement unit 14 is specifically configured to extract second feature information of the reconstructed picture block based on the quantization parameter, and obtain the first feature information of the reconstructed picture block by performing feature weighting on the second feature information.

In some embodiments, the enhancement unit 14 is specifically configured to obtain concatenated information by concatenating the reconstructed picture block and the quantization parameter, and obtain the second feature information by performing feature extraction on the concatenated information.

In some embodiments, the enhancement unit 14 is specifically configured to obtain the second feature information by performing feature extraction on the concatenated information through a second feature-extraction module.

Optionally, the second feature-extraction module includes at least one convolutional layer.

In some embodiments, the enhancement unit 14 is specifically configured to obtain the first feature information of the reconstructed picture block according to the N-th feature information and at least one of first N-1 feature information prior to the N-th feature information.

In some embodiments, the enhancement unit 14 is specifically configured to obtain second concatenated feature information by concatenating the at least one of the first N-1 feature information, the N-th feature information, and the second feature information, and obtain the first feature information of the reconstructed picture block by performing feature extraction on the second concatenated feature information.

In some embodiments, the enhancement unit 14 is specifically configured to obtain the enhanced picture block by performing nonlinear mapping on the first feature information of the reconstructed picture block.

In some embodiments, the enhancement unit 14 is specifically configured to obtain the enhanced picture block by performing nonlinear mapping on the first feature information of the reconstructed picture block through a reconstruction module.

Optionally, the reconstruction module includes at least one convolutional layer.

In some embodiments, the decoding unit 11 is further configured to decode the bitstream to obtain a first flag, where the first flag indicates whether to perform quality enhancement on the reconstructed picture block of the current picture block. The enhancement unit 14 is further configured to obtain the enhanced picture block by performing quality enhancement on the reconstructed picture block based on the quantization parameter, based on a determination according to the first flag that quality enhancement is allowed for the reconstructed picture block.

In some embodiments, the enhancement unit 14 is further configured to obtain a test enhanced picture block by performing quality enhancement on the reconstructed picture block based on the quantization parameter, determine a first picture quality of the test enhanced picture block and a second picture quality of the reconstructed picture block, and determine the test enhanced picture block as the enhanced picture block of the reconstructed picture block if the first picture quality is greater than the second picture quality.

Optionally, the reconstructed picture block is a reconstructed picture block of the current picture block for a first component.

Optionally, the first component is a luma component or a chroma component.

In some embodiments, the enhancement unit 14 is specifically configured to normalize the reconstructed picture block and the quantization parameter, and obtain the enhanced picture block based on the normalized reconstructed picture block and the normalized quantization parameter.

It should be understood that, the apparatus embodiments and the method embodiments may correspond to each other, and for similar descriptions, reference can be made to the method embodiments, which will not be elaborated again herein to avoid redundancy. Specifically, the apparatus 10 illustrated in FIG. 22 may perform the method for picture processing at the decoding end in embodiments of the disclosure, and the foregoing and other operations and/or functions of various units in the apparatus 10 are respectively intended to implement corresponding processes in the foregoing methods such as the method for picture processing at the decoding end, which are not described again herein for brevity.

FIG. 23 is a schematic block diagram of an apparatus for picture processing provided in embodiments of the disclosure.

As illustrated in FIG. 23, the apparatus for picture processing 20 includes a determination unit 21, an inverse quantization unit 22, a reconstruction unit 23, and an enhancement unit 24. The determination unit 21 is configured to determine a quantization parameter of a current picture block, and encode the current picture block based on the quantization parameter to obtain a quantization coefficient of the current picture block. The inverse quantization unit 22 is configured to obtain a residual block of the current picture block by performing inverse quantization on the quantization coefficient based on the quantization parameter of the current picture block. The reconstruction unit 23 is configured to obtain a reconstructed picture block of the current picture block according to the residual block. The enhancement unit 24 is configured to obtain an enhanced picture block by performing quality enhancement on the reconstructed picture block based on the quantization parameter.

In some embodiments, the enhancement unit 24 is specifically configured to obtain first feature information of the reconstructed picture block by performing feature weighting on the reconstructed picture block based on the quantization parameter, and determine the enhanced picture block according to the first feature information.

In some embodiments, the enhancement unit 24 is specifically configured to obtain i-th feature information of the reconstructed picture block by performing feature weighting on (i-1)-th feature information of the reconstructed picture block based on the quantization parameter, where i is a positive integer from 1 to N, and obtain N-th feature information of the reconstructed picture block by repeating feature weighting, where when i=1, the (i-1)-th feature information is the reconstructed picture block, and determine the first feature information of the reconstructed picture block according to the N-th feature information.

In some embodiments, the enhancement unit 24 is specifically configured to extract M feature information of different scales from the (i-1)-th feature information, where M is a positive integer greater than 1, obtain i-th weighted feature information by weighting the M feature information of different scales, and determine the i-th feature information according to the i-th weighted feature information.

In some embodiments, the enhancement unit 24 is specifically configured to extract the M feature information of different scales from the (i-1)-th feature information through M first feature-extraction layers of different scales.

In some embodiments, the first feature-extraction layer includes a convolution layer, and different first feature-extraction layers include convolution layers with convolution kernels of different sizes.

In some embodiments, among the M first feature-extraction layers of different scales, at least one first feature-extraction layer includes an activation function.

In some embodiments, the enhancement unit 24 is specifically configured to obtain first concatenated feature information by concatenating the M feature information of different scales, and obtain the i-th weighted feature information by weighting the first concatenated feature information.

In some embodiments, the enhancement unit 24 is specifically configured to obtain weighted feature information with a first number of channels by weighting the first concatenated feature information through a weighting layer, and obtain the i-th weighted feature information according to the weighted feature information with the first number of channels.

In some embodiments, a number of channels of the i-th weighted feature information is the same as a number of channels of the (i-1)-th feature information. Optionally, the weighting layer includes a neuron attention mechanism.

In some embodiments, the enhancement unit 24 is specifically configured to determine a sum of the i-th weighted feature information and the (i-1)-th feature information as the i-th feature information.

In some embodiments, the enhancement unit 24 is specifically configured to determine the i-th weighted feature information as the i-th feature information.

In some embodiments, the enhancement unit 24 is specifically configured to extract second feature information of the reconstructed picture block based on the quantization parameter, and obtain the first feature information of the reconstructed picture block by performing feature weighting on the second feature information.

In some embodiments, the enhancement unit 24 is specifically configured to obtain concatenated information by concatenating the reconstructed picture block and the quantization parameter, and obtain the second feature information by performing feature extraction on the concatenated information.

In some embodiments, the enhancement unit 24 is specifically configured to obtain the second feature information by performing feature extraction on the concatenated information through a second feature-extraction module.

Optionally, the second feature-extraction module includes at least one convolutional layer.

In some embodiments, the enhancement unit 24 is specifically configured to obtain the first feature information of the reconstructed picture block according to the N-th feature information and at least one of first N-1 feature information prior to the N-th feature information.

In some embodiments, the enhancement unit 24 is specifically configured to obtain second concatenated feature information by concatenating the at least one of the first N-1 feature information, the N-th feature information, and the second feature information, and obtain the first feature information of the reconstructed picture block by performing feature extraction on the second concatenated feature information.

In some embodiments, the enhancement unit 24 is specifically configured to obtain the enhanced picture block by performing nonlinear mapping on the first feature information of the reconstructed picture block.

In some embodiments, the enhancement unit 24 is specifically configured to obtain the enhanced picture block by performing nonlinear mapping on the first feature information of the reconstructed picture block through a reconstruction module, where the reconstruction module includes at least one convolution layer.

Optionally, the reconstruction module includes at least one convolutional layer.

In some embodiments, the encoding unit 22 is further configured to signal a first flag in a bitstream, where the first flag indicates whether to perform quality enhancement on the reconstructed picture block of the current picture block.

Optionally, the reconstructed picture block is a reconstructed picture block of the current picture block for a first component.

Optionally, the first component is a luma component or a chroma component.

In some embodiments, the enhancement unit 24 is specifically configured to normalize the reconstructed picture block and the quantization parameter, and obtain the enhanced picture block based on the normalized reconstructed picture block and the normalized quantization parameter.

It should be understood that, the apparatus embodiments and the method embodiments may correspond to each other, and for similar elaborations, reference can be made to the method embodiments, which will not be described again herein to avoid redundancy. Specifically, the apparatus 20 illustrated in FIG. 23 may correspond to a corresponding entity for performing the method for picture processing at the encoding end according to embodiments of the disclosure, and the foregoing and other operations and/or functions of various units in the apparatus 20 are respectively intended to implement corresponding processes of various methods such as the method for picture processing at the encoding end, which will not be repeated herein for brevity.

The apparatus and system of embodiments of the disclosure are described above from the perspective of functional units with reference to the accompanying drawings. It should be understood that, the functional unit may be implemented in the form of hardware, or may be implemented by an instruction in the form of software, or may be implemented by a combination of hardware and software unit. Specifically, each step of the method embodiments of the disclosure may be completed by an integrated logic circuit of hardware in a processor and/or an instruction in the form of software. The steps of the method disclosed in embodiments of the disclosure may be directly implemented by a hardware decoding processor, or may be performed by hardware and software units in the decoding processor. Optionally, the software unit may be located in a storage medium such as a random access memory (RAM), a flash memory, a read only memory (ROM), a programmable ROM (PROM), or an electrically erasable programmable memory, registers, and the like. The storage medium is located in a memory. The processor reads the information in the memory, and completes the steps of the foregoing method embodiments with the hardware of the processor.

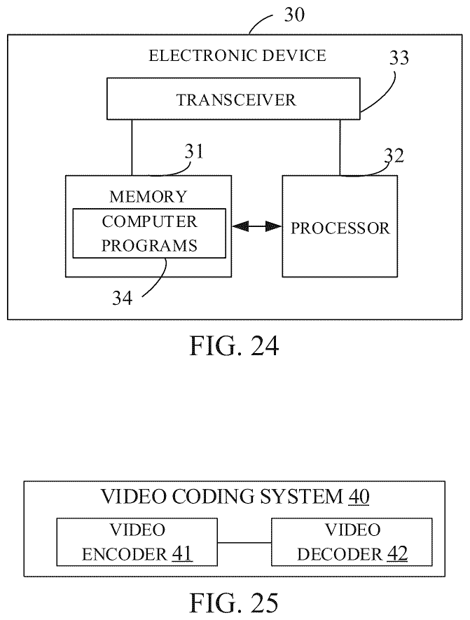

FIG. 24 is a schematic block diagram of an electronic device provided in

embodiments of the disclosure.

As illustrated in FIG. 24, the electronic device 30 may be a video encoder or a video decoder according to embodiments of the disclosure. The electronic device 30 may include a memory 33 and a processor 32. The memory 33 is configured to store computer programs 34 and transmit the program codes 34 to the processor 32. In other words, the processor 32 may call the computer programs 34 from the memory 33 to implement the method in embodiments of the disclosure.

For example, the processor 32 may be configured to perform the steps in the method 200 described above according to instructions in the computer programs 34.

In some embodiments of the disclosure, the processor 32 may include, but is not limited to: a general-purpose processor, a digital signal processor (DSP), an application specific integrated circuit (ASIC), a field programmable gate array (FPGA), or other programmable logic devices, discrete gates or transistor logic devices, discrete hardware components, etc.

In some embodiments of the disclosure, the memory 33 includes, but is not limited to: a volatile memory and/or a non-volatile memory. The non-volatile memory may be a ROM, a PROM, an erasable PROM (EPROM), an electrically EPROM (EEPROM), or flash memory. The volatile memory can be a RAM that acts as an external cache. By way of example but not limitation, many forms of RAM are available, such as a static RAM (SRAM), a dynamic RAM (DRAM), a synchronous DRAM (SDRAM), a double data rate SDRAM (DDR SDRAM), an enhanced SDRAM (ESDRAM), a synch link DRAM (SLDRAM), and a direct rambus RAM (DR RAM).

In some embodiments of the disclosure, the computer program 34 may be divided into one or more units, and the one or more units are stored in the memory 33 and executed by the processor 32 to complete the method provided in the disclosure. The one or more units may be a series of computer program instruction segments capable of performing particular functions, where the instruction segments are used for describing the execution of the computer program 34 in the electronic device 30.

As illustrated in FIG. 24, the electronic device 30 may further include a transceiver 33. The transceiver 33 may be connected to the processor 32 or the memory 33.

The processor 32 can control the transceiver 33 to communicate with other devices, and specifically, can send information or data to other devices, or receive information or data sent by other devices. The transceiver 33 may further include an antenna, where one or more antennas may be provided.

It should be understood that, various components in the electronic device 30 are connected via a bus system. In addition to a data bus, the bus system further includes a power bus, a control bus, and a status signal bus.

FIG. 25 is a schematic block diagram of a video coding system provided in embodiments of the disclosure.

As illustrated in FIG. 25, the video coding system 40 may include a video encoder 41 and a video decoder 42. The video encoder 41 is configured to perform the video encoding method in embodiments of the disclosure, and the video decoder 42 is configured to perform a method for video decoding in embodiments of the disclosure.

The disclosure further provides a computer storage medium. The computer storage medium is configured to store computer programs. The computer programs, when executed by a computer, are operable with the computer to perform the method in the foregoing method embodiments. Alternatively, embodiments of the disclosure further provide a computer program product. The computer program product includes instructions which, when executed by a computer, are operable with the computer to perform the method in the foregoing method embodiments.

The disclosure further provides a bitstream. The bitstream is generated through the encoding method. Optionally, the bitstream contains the first flag.

When implemented by software, all or some the above embodiments can be implemented in the form of a computer program product. The computer program product includes one or more computer instructions. When the computer instructions are applied and executed on a computer, all or some the operations or functions of the embodiments of the disclosure are performed. The computer can be a general-purpose computer, a special-purpose computer, a computer network, or other programmable apparatuses. The computer instruction can be stored in a computer-readable storage medium, or transmitted from one computer-readable storage medium to another computer-readable storage medium. For example, the computer instruction can be transmitted from one website, computer, server, or data center to another website, computer, server, or data center in a wired manner or in a wireless manner. Examples of the wired manner can be a coaxial cable, an optical fiber, a digital subscriber line (DSL), etc. The wireless manner can be, for example, infrared, wireless, microwave, etc. The computer-readable storage medium can be any computer accessible usable-medium or a data storage device such as a server, a data center, or the like which integrates one or more usable media. The usable medium can be a magnetic medium (such as a soft disk, a hard disk, or a magnetic tape), an optical medium (such as a digital video disc (DVD)), or a semiconductor medium (such as a solid state disk (SSD)), etc.

Those of ordinary skill in the art will appreciate that units and algorithmic operations of various examples described in connection with embodiments of the disclosure can be implemented by electronic hardware or by a combination of computer software and electronic hardware. Whether these functions are performed by means of hardware or software depends on the application and the design constraints of the associated technical solution. Those skilled in the art may use different methods with regard to each particular application to implement the described functionality, but such methods should not be regarded as lying beyond the scope of the disclosure.

It will be appreciated that the systems, apparatuses, and methods disclosed in embodiments of the disclosure may also be implemented in various other manners. For example, the above apparatus embodiments are merely illustrative, e.g., the division of units is only a division of logical functions, and other manners of division may be available in practice, e.g., multiple units or assemblies may be combined or may be integrated into another system, or some features may be ignored or skipped. In other respects, the coupling or direct coupling or communication connection as illustrated or discussed may be an indirect coupling or communication connection through some interface, device, or unit, and may be electrical, mechanical, or otherwise.

Separated units as illustrated may or may not be physically separated. Components displayed as units may or may not be physical units, and may reside at one location or may be distributed to multiple networked units. Some or all of the units may be selectively adopted according to practical needs to achieve desired objectives of the disclosure. For example, various functional units described in various embodiments of the disclosure may be integrated into one processing unit or may be present as a number of physically separated units, and two or more units may be integrated into one.

The foregoing elaborations are merely implementations of the disclosure, but are not intended to limit the protection scope of the disclosure. Any variation or replacement easily thought of by those skilled in the art within the technical scope disclosed in the disclosure shall belong to the protection scope of the disclosure. Therefore, the protection scope of the disclosure shall be subjected to the protection scope of the claims.

What is claimed is:

1. A method for picture processing, comprising:
decoding a bitstream to obtain a quantization coefficient of a current picture block;
determining a quantization parameter corresponding to the current picture block, and obtaining a transform coefficient of the current picture block by performing inverse quantization on the quantization coefficient based on the quantization parameter;
determining a reconstructed picture block of the current picture block according to the transform coefficient; and
obtaining an enhanced picture block by performing quality enhancement on the reconstructed picture block based on the quantization parameter.

2. The method of claim 1, wherein obtaining the enhanced picture block by performing quality enhancement on the reconstructed picture block based on the quantization parameter comprises:
obtaining first feature information of the reconstructed picture block by performing feature weighting on the reconstructed picture block based on the quantization parameter; and
determining the enhanced picture block according to the first feature information.

3. The method of claim 2, wherein obtaining the first feature information of the reconstructed picture block by performing feature weighting on the reconstructed picture block based on the quantization parameter comprises:
obtaining i-th feature information of the reconstructed picture block by performing feature weighting on (i-1)-th feature information of the reconstructed picture block based on the quantization parameter, where i is a positive integer from 1 to N, and obtaining N-th feature information of the reconstructed picture block by repeating feature weighting, wherein when i=1, the (i-1)-th feature information is the reconstructed picture block; and
determining the first feature information of the reconstructed picture block according to the N-th feature information.

4. The method of claim 3, wherein obtaining the i-th feature information of the reconstructed picture block by performing feature weighting on the (i-1)-th feature information of the reconstructed picture block based on the quantization parameter comprises:
extracting M feature information of different scales from the (i-1)-th feature information, where M is a positive integer greater than 1;
obtaining i-th weighted feature information by weighting the M feature information of different scales; and
determining the i-th feature information according to the i-th weighted feature information.

5. The method of claim 4, wherein obtaining the i-th weighted feature information by weighting the M feature information of different scales comprises:
obtaining first concatenated feature information by concatenating the M feature information of different scales; and
obtaining the i-th weighted feature information by weighting the first concatenated feature information.

6. The method of claim 4, wherein determining the i-th feature information according to the i-th weighted feature information comprises:
determining a sum of the i-th weighted feature information and the (i-1)-th feature information as the i-th feature information; or
determining the i-th weighted feature information as the i-th feature information.

7. The method of claim 3, wherein obtaining the first feature information of the reconstructed picture block by performing feature weighting on the reconstructed picture block based on the quantization parameter comprises:
extracting second feature information of the reconstructed picture block based on the quantization parameter; and
obtaining the first feature information of the reconstructed picture block by performing feature weighting on the second feature information.

8. The method of claim 7, wherein extracting the second feature information of the reconstructed picture block based on the quantization parameter comprises:
obtaining concatenated information by concatenating the reconstructed picture block and the quantization parameter; and
obtaining the second feature information by performing feature extraction on the concatenated information.

9. The method of claim 7, wherein determining the first feature information of the reconstructed picture block according to the N-th feature information comprises:
obtaining the first feature information of the reconstructed picture block according to the N-th feature information and at least one of first N-1 feature information prior to the N-th feature information.

10. The method of claim 9, wherein obtaining the first feature information of the reconstructed picture block according to the N-th feature information and the at least one of the first N-1 feature information prior to the N-th feature information comprises:
obtaining second concatenated feature information by concatenating the at least one of the first N-1 feature information, the N-th feature information, and the second feature information; and
obtaining the first feature information of the reconstructed picture block by performing feature extraction on the second concatenated feature information.

11. The method of claim 1, further comprising:
decoding the bitstream to obtain a first flag, wherein the first flag indicates whether quality enhancement is allowed for the reconstructed picture block of the current picture block;
wherein obtaining the enhanced picture block by performing quality enhancement on the reconstructed picture block based on the quantization parameter comprises:
obtaining the enhanced picture block by performing quality enhancement on the reconstructed picture block based on the quantization parameter, based on a determination according to the first flag that quality enhancement is allowed for the reconstructed picture block.

12. The method of claim 1, further comprising:
obtaining a test enhanced picture block by performing quality enhancement on the reconstructed picture block based on the quantization parameter; and
determining a first picture quality of the test enhanced picture block and a second picture quality of the reconstructed picture block;
wherein obtaining the enhanced picture block by performing quality enhancement on the reconstructed picture block based on the quantization parameter comprises:
determining the test enhanced picture block as the enhanced picture block of the reconstructed picture block if the first picture quality is greater than the second picture quality.

13. The method of claim 1, wherein obtaining the enhanced picture block by performing quality enhancement on the reconstructed picture block based on the quantization parameter comprises:
normalizing the reconstructed picture block and the quantization parameter; and
obtaining the enhanced picture block based on the normalized reconstructed picture block and the normalized quantization parameter.

14. A method for picture processing, comprising:
determining a quantization parameter of a current picture block, and encoding the current picture block based on the quantization parameter to obtain a quantization coefficient of the current picture block;
obtaining a residual block of the current picture block by performing inverse quantization on the quantization coefficient based on the quantization parameter of the current picture block;
obtaining a reconstructed picture block of the current picture block according to the residual block; and
obtaining an enhanced picture block by performing quality enhancement on the reconstructed picture block based on the quantization parameter.

15. The method of claim 14, wherein obtaining the enhanced picture block by performing quality enhancement on the reconstructed picture block based on the quantization parameter comprises:
obtaining first feature information of the reconstructed picture block by performing feature weighting on the reconstructed picture block based on the quantization parameter; and
determining the enhanced picture block according to the first feature information.

16. The method of claim 15, wherein obtaining the first feature information of the reconstructed picture block by performing feature weighting on the reconstructed picture block based on the quantization parameter comprises:
obtaining i-th feature information of the reconstructed picture block by performing feature weighting on (i-1)-th feature information of the reconstructed picture block based on the quantization parameter, where i is a positive integer from 1 to N, and obtaining N-th feature information of the reconstructed picture block by repeating feature weighting, wherein when i=1, the (i-1)-th feature information is the reconstructed picture block; and
determining the first feature information of the reconstructed picture block according to the N-th feature information.

17. The method of claim 16, wherein obtaining the i-th feature information of the reconstructed picture block by performing feature weighting on the (i-1)-th feature information of the reconstructed picture block based on the quantization parameter comprises:
extracting M feature information of different scales from the (i-1)-th feature information, where M is a positive integer greater than 1;
obtaining i-th weighted feature information by weighting the M feature information of different scales; and
determining the i-th feature information according to the i-th weighted feature information.

18. The method of claim 16, wherein obtaining the first feature information of the reconstructed picture block by performing feature weighting on the reconstructed picture block based on the quantization parameter comprises:
extracting second feature information of the reconstructed picture block based on the quantization parameter; and
obtaining the first feature information of the reconstructed picture block by performing feature weighting on the second feature information.

19. The method of claim 14, further comprising:
obtaining a first flag, wherein the first flag indicates whether quality enhancement is allowed for the reconstructed picture block of the current picture block;
wherein obtaining the enhanced picture block by performing quality enhancement on the reconstructed picture block based on the quantization parameter comprises:
obtaining the enhanced picture block by performing quality enhancement on the reconstructed picture block based on the quantization parameter, based on a determination according to the first flag that quality enhancement is allowed for the reconstructed picture block.

20. A non-transitory computer-readable storage medium storing a bitstream, the bitstream being generated according to the method of claim 14.
